(19) United States
(12) Patent Application Publication
(10) Pub. No.: US 2014/0106030 A1
(43) Pub. Date: Apr. 17, 2014

(54) Probiotics with Enhanced Survival Properties

(71) Applicant: FRIESLAND BRANDS B.V., Amersfoort (NL)

(72) Inventors: Hermien Van Bokhorst-Van De Veen, Nijkerk (NL); Lee I-Chiao, Wageningen (NL); Michiel Wouter Wilhelmus Wels, Rosmalen (NL); Paulus De Vos, Slochteren (NL); Peter Allard Bron, Wageningen (NL); Roger Samuel Bongers, Ede (NL); Anne Wiersma, Ede (NL); Michiel Kleerebezem, Ede (NL); Arjen Nauta, Bennekom (NL)

(21) Appl. No.: 14/115,321

(22) PCT Filed: Apr. 26, 2012
(86) PCT No.: PCT/NL2012/050284

§ 371 Date: Dec. 16, 2013

Related U.S. Application Data
(60) Provisional application No. 61/481,426, filed on May 2, 2011.
(60) Provisional application No. 61/576,544, filed on Dec. 16, 2011.

(30) Foreign Application Priority Data
May 2, 2011 (EP) 11164469.6
Dec. 16, 2011 (EP) 11194080.5

(51) Int. Cl. A23L 1/30

(52) U.S. Cl. CPC A23L 1/3014
USPC 426/61; 435/252.3

(57) ABSTRACT

The present invention relates to a method for screening for a bacterium exhibiting enhanced survival properties in the gastro-intestinal tract. The present invention further relates to a method for screening for culture conditions that provide a bacterium exhibiting enhanced survival properties in the gastro-intestinal tract. The present invention further relates to a method for modulating the expression of certain polynucleotides. The present invention further relates to a method for the preparation of a bacterium exhibiting enhanced survival properties in the gastro-intestinal tract. The present invention further relates to a bacterium exhibiting enhanced survival properties in the gastro-intestinal tract. The present invention further relates to a method for the preparation of a food composition. The present invention further relates to a food composition. The present invention further relates to the use of certain polynucleotides in the screening for a bacterium exhibiting enhanced survival properties in the gastro-intestinal tract and/or the screening for culture conditions that provide a bacterium exhibiting enhanced survival properties in the gastro-intestinal tract and/or for the control of culture conditions providing a bacterium exhibiting enhanced survival properties in the gastro-intestinal tract. The present invention further relates to a method for controlling culture conditions providing a bacterium exhibiting enhanced survival properties in the gastro-intestinal tract.

### FIELD OF THE INVENTION

The present invention relates to a method for screening for a bacterium exhibiting enhanced survival properties in the gastro-intestinal tract. The present invention further relates to a method for screening for culture conditions that provide a bacterium exhibiting enhanced survival properties in the gastro-intestinal tract. The present invention further relates to a method for modulating the expression of certain polynucleotides. The present invention further relates to a method for the preparation of a bacterium exhibiting enhanced survival properties in the gastro-intestinal tract. The present invention further relates to a bacterium exhibiting enhanced survival properties in the gastro-intestinal tract. The present invention further relates to a method for the preparation of a food composition. The present invention further relates to a food composition. The present invention further relates to the use of certain polynucleotides in the screening for a bacterium exhibiting enhanced survival properties in the gastro-intestinal tract and/or the screening for culture conditions that provide a bacterium exhibiting enhanced survival properties in the gastro-intestinal tract and/or for the control of culture conditions providing a bacterium exhibiting enhanced survival properties in the gastro-intestinal tract. The present invention further relates to a method for controlling culture conditions providing a bacterium exhibiting enhanced survival properties in the gastro-intestinal tract.

### BACKGROUND

Probiotics are live microorganisms which, when administered in adequate amounts, confer a health benefit on the host (FAO/WHO, Evaluation of health and nutritional properties of powder milk with live lactic acid bacteria. Report of FAO/WHO expert consultation 1-4 Oct. 2001.). The most widely applied probiotics belong to the genera Lactobacillus and Bifidobacterium (Marco, M. L., S. Pavan, and M. Kleerebezem, Towards understanding molecular modes of probiotic action. Curr Opin Biotechnol, 2006. 17(2): p. 204-10.). Their beneficial effects are exerted via several mechanisms, including the modulation of the intestinal microbiota, the production of antibacterial substances, improvement of epithelial barrier function, and reduction of intestinal inflammation (Corr, S. C., C. Hill, and C. G. Gahan, Understanding the mechanisms by which probiotics inhibit gastrointestinal pathogens. Adv Food Nutr Res, 2009. 56: p. 1-15; Saulnier, D. M. A., et al., Mechanisms of probiosis and probiosis: considerations for enhanced functional foods. Current Opinion in Biotechnology, 2009. 20(2): p. 135-141; Saxelin, M., et al., Probiotic and other functional microbes: from markets to mechanisms. Curr Opin Biotechnol, 2005. 16(2): p. 204-11). Probiotics are most commonly provided through ingestion of freshly fermented food products or dried bacterial preparations. The viability of probiotic strains is considered an important trait for probiotic functionality; reaching their side of action in the intestine alive is thus considered an important trait for probiotic strains (Ma, D., P. Forsythe, and J. Bienenstock, Live Lactobacillus reuteri is essential for the inhibitory effect on tumor necrosis factor alpha-induced interleukin-8 expression. Infect Immun, 2004. 72(9): p. 5308-14; Gobbetti, M., R. D. Cagno, and M. De Angelis, Functional microorganisms for functional food quality. Crit Rev Food Sci Nutr, 2010. 50(8): p. 716-27).

During passage of the consumer's GI-tract, probiotics encounter several stresses, including acidity in the stomach, exposure to bile and digestive enzymes in the intestine, as well as osmotic stress in the colon and highly variable oxygen levels throughout the digestive tract. The human stomach is a harsh environment for probiotics where the pH may range from 1 to 5 during fasting and following food intake, respectively (Corcoran, B. M., et al., Life under stress: The probiotic stress response and how it may be manipulated. Current Pharmaceutical Design, 2008. 14(14): p. 1382-1399). At low pH bacteria can adapt by lowering the intracellular pH, which affects the proton motive force, and thereby may negatively affect the energy supply to important processes like transmembrane transport (van de Guchte, M., et al., Stress responses in lactic acid bacteria. Antonie Van Leeuwenhoek, 2002. 82(1-4): p. 187-216). In addition, lower intracellular pH values may damage acid-sensitive enzyme functions and/or DNA (van de Guchte, M., et al., supra). In the small intestine bile acts as a detergent for probiotics and disrupts bacterial membranes (Watson, D., et al., Enhancing bile tolerance improves survival and persistence of Bifidobacterium and Lactococcus in the murine gastrointestinal tract. BMC Microbiol, 2008. 8: p. 176). In addition to affecting membrane integrity, bile acids can damage macromolecules such as RNA and DNA and leads to the generation of free oxygen radicals, causing oxidative stress (Begley, M., C. G. Gahan, and C. Hill, The interaction between bacteria and bile. FEMS Microbiol Rev, 2005. 29(4): p. 625-51). The protonated forms of bile salts can freely cross cell membranes and release protons intracellularly. This reduces the intracellular pH, resulting in similar damage as acid stress. Nevertheless, the main effect of bile is disturbing of bacterial membranes (van de Guchte, M., et al., supra).

Accordingly, there is a need for probiotics with enhanced survival properties in the gastrointestinal tract.

### DETAILED DESCRIPTION OF THE INVENTION

Surprisingly, it has now been demonstrated that reduced expression of one or more polynucleotides encoding a polypeptide having at least 30% sequence identity with the amino acid sequence of either SEQ ID NO: 1, 2 or 3 correlates with enhanced survival properties in the gastro-intestinal tract. In addition, it has been now been demonstrated that the composition of the capsular polysaccharide (CPS) is correlated with enhanced survival properties in the gastro-intestinal tract.

In a first aspect, the present invention provides a method for screening for a bacterium exhibiting enhanced survival properties in the gastro-intestinal tract, said method comprising:
a) providing a population of bacteria,
b) culturing said population of bacteria,
c) sampling at least one subpopulation of bacteria from said culture,
d) determining in said subpopulation of bacteria the expression level of one or more polynucleotides selected from the group consisting of:
   i. a polynucleotide encoding a polypeptide having at least 30% sequence identity with the amino acid sequence of SEQ ID NO: 1,
   ii. a polynucleotide encoding a polypeptide having at least 30% sequence identity with the amino acid sequence of SEQ ID NO: 2, and
   iii. a polynucleotide encoding a polypeptide having at least 30% sequence identity with the amino acid sequence of SEQ ID NO: 3,
e) identifying a subpopulation of bacteria with reduced expression of one or more polynucleotides selected from the group consisting of i), ii) and iii), and optionally isolating and/or purifying said identified subpopulation to obtain a bacterium exhibiting enhanced survival properties in the gastro-intestinal tract.

Preferably, in addition to or instead of determining in the expression level of one or more polynucleotides selected from the group consisting of:
i. a polynucleotide encoding a polypeptide having at least 30% sequence identity with the amino acid sequence of SEQ ID NO: 1,
ii. a polynucleotide encoding a polypeptide having at least 30% sequence identity with the amino acid sequence of SEQ ID NO: 2, and
iii. a polynucleotide encoding a polypeptide having at least 30% sequence identity with the amino acid sequence of SEQ ID NO: 3,
   the composition of the capsular polysaccharide (CPS) is determined from the subpopulation of (d) here above and a subpopulation is identified with a modified CPS composition and is optionally isolated and/or purified to obtain a bacterium exhibiting enhanced survival properties in the gastro-intestinal tract.

A modified CPS composition is for all embodiments of the invention preferably defined as modified relative to the CPS composition of a parent bacterium or a of parent population of bacteria where the bacterium or population of bacteria, respectively, derives from. The parent bacterium (or parent population) preferably is a probiotic bacterium. More preferably, the probiotic bacterium is a bacterium selected from the group consisting of the genera of Lactobacillus, Lactococcus, Leuconostoc, Carnobacterium, Streptococcus, Bifidobacterium, Bacteroides, Eubacterium, Clostridium, Fusobacterium, Propionibacterium, Enterococcus, Staphylococcus, Peptostreptococcus, and Escherichia, preferably consisting of Lactobacillus and Bifidobacterium. Preferred species of Lactobacillus and Bifidobacterium are L. reuteri, L. fermentum, L. acidophilus, L. crispatus, L. gasseri, L. johnsonii, L. plantarum, L. paracasei, L. murinus, L. jensenii, L. salivarius, L. minutis, L. brevis, L. gallinarum, L. amylovorus, B. bifidum, B. longum, B. infantis, B. breve, B. adolescente, B. animalis, B. gallinarum, B. magnum, and B. thermophilum. The Lactobacillus bacterium is preferably Lactobacillus plantarum, more preferably a Lactobacillus plantarum from the group consisting of Lactobacillus plantarum JDM1, ST-III, F9UP33, EITR17, D7V971 (ATCC14917) and C6VQ24 and most preferably Lactobacillus plantarum WCFS1.

Preferably, the modified CPS composition in all embodiments of the invention comprises:
a higher relative total molar mass (kg/mol), preferably 10%, 20%, 30%, 40%, 50%, 60%, 70%, 80%, 90%, 100%, 120%, 130%, 150% higher, and/or
a total molar mass of at least 21, 22, 23, 24, 25, 26, 27, 28, 29, 30 kg/mol, and/or
galactosamine and no arabinose, or
at least 0.1%, 0.2%, 0.3%, 0.4%, 0.5%, 0.6%, 0.7%, 0.8%, 0.9%, 1.0%, 1.1%, 1.2%, 1.3%, 1.4%, 1.5% galactosamine of total CPS sugars, and/or
less than 1%, 0.9%, 0.8%, 0.7%, 0.6%, 0.5%, 0.4%, 0.3%, 0.2%, 0.1%, 0.05%, 0.01% arabinose of total CPS sugars, and/or
at least 10%, 20%, 30%, 40%, 50%, 60%, 70%, 80%, 90%, 95%, 96%, 97%, 98%, 99%, 100% less arabinose, and/or
at least 10%, 20%, 30%, 40%, 50%, 60%, 70%, 80%, 90%, 100%, 150%, 200%, 300%, 400%, 500%, 800%, 1000% more galactosamine; and/or comprises:
a total molar mass of at least 21, 22, 23, 24, 25, 26, 27, 28, 29, 30 kg/mol, and/or
galactosamine and no arabinose.

A preferred modified CPS composition according to the invention may comprise a higher relative total molar mass (kg/mol), preferably 10%, 20%, 30%, 40%, 50%, 60%, 70%, 80%, 90%, 100%, 120%, 130%, 150% higher.

A preferred modified CPS composition according to the invention may comprise a total molar mass of at least 21, 22, 23, 24, 25, 26, 27, 28, 29, 30 kg/mol.

A preferred CPS composition according to the invention may comprise galactosamine and no arabinose.

A preferred modified CPS composition according to the invention may comprise at least 0.1%, 0.2%, 0.3%, 0.4%, 0.5%, 0.6%, 0.7%, 0.8%, 0.9%, 1.0%, 1.1%, 1.2%, 1.3%, 1.4%, 1.5% galactosamine of total CPS sugars.

A preferred modified CPS composition according to the invention may comprise less than 1%, 0.9%, 0.8%, 0.7%, 0.6%, 0.5%, 0.4%, 0.3%, 0.2%, 0.1%, 0.05%, 0.01% arabinose of total CPS sugars.

A preferred modified CPS composition according to the invention may comprise at least 10%, 20%, 30%, 40%, 50%, 60%, 70%, 80%, 90%, 95%, 96%, 97%, 98%, 99%, 100% less arabinose.

A preferred modified CPS composition according to the invention may comprise at least 10%, 20%, 30%, 40%, 50%, 60%, 70%, 80%, 90%, 100%, 150%, 200%, 300%, 400%, 500%, 800%, 1000% more galactosamine.

A preferred modified CPS composition according to the invention may comprise at least 0.1%, 0.2%, 0.3%, 0.4%, 0.5%, 0.6%, 0.7%, 0.8%, 0.9%, 1.0%, 1.1%, 1.2%, 1.3%, 1.4%, 1.5% galactosamine of total CPS sugars and less than 1%, 0.9%, 0.8%, 0.7%, 0.6%, 0.5%, 0.4%, 0.3%, 0.2%, 0.1%, 0.05%, 0.01% arabinose of total CPS sugars.

A preferred modified CPS composition according to the invention may comprise at least 10%, 20%, 30%, 40%, 50%, 60%, 70%, 80%, 90%, 95%, 96%, 97%, 98%, 99%, 100° A less arabinose and at least 10%, 20%, 30%, 40%, 50%, 60%, 70%, 80%, 90%, 100%, 150%, 200%, 300%, 400%, 500%, 800%, 1000% more galactosamine.

A preferred modified CPS composition according to the invention may comprise a total molar mass of at least 21, 22, 23, 24, 25, 26, 27, 28, 29, 30 kg/mol and galactosamine and no arabinose.

In any embodiment of the invention, “no arabinose” is defined as preferably less than 0.2%, more preferably less than 0.1%, 0.9%, 0.8%, 0.7%, 0.6%, 0.5%, 0.4%, 0.3%, 0.2%, 0.1%, 0.05%, 0.01%, 0.001 of the percentage of total CPS sugars is arabinose. Preferably, arabinose percentage is below the detection limit.

In any embodiment of the invention, the CPS composition may be determined according to any technique known to the person skilled in the art. Preferably, the following assay, as also described in the examples, is used; in brief: CPS is purified and chain lengths and sugar groups were determined essentially as described before (Looijesteijn et al, 1999). In short, 500 ml cultures of bacteria are grown in 2×CDM until stationary phase (25 h). After 1 h incubation at 55° C., the cells are separated from the CPS containing growth medium by centrifugation for 15 min (6000×g) and to prevent overgrowth during dialysis, erythromicine is added to the supernatant to a final concentration of 10 μg/ml. A dialyzing tube 12-1400 Da (Fisher Scientific) is prepared by boiling twice 2% NaHCO₃/2 mM EDTA, and once in reverse osmosis water. After overnight dialysis against running tap water followed by 4 h dialysis using reverse osmosis water, the samples are freeze-dried and stored at −20° C. until further analysis.

The samples are dissolved in eluent (in-line vacuum degassed 100 mM NaNO₃+0.02% NaN₃), filter sterilized, and placed in a thermally controlled sample holder at 10° C. and 200 μl is injected on the columns (model 231 Bio, Gilson) to perform size exclusion chromatography (SEC) [TSK gel PWXL guard column, 6.0 mm×4.0 cm, TSK gel G6000 PWXL analytical column, 7.8 mm×30 cm, 13.0 μm and TSK gel G5000 PWXL analytical column, 7.8 mm×30 cm, 10 μm (TosoHaas, King of Prussio, USA) connected in series and thermostated at 35° C. with a temperature control module (Waters, Milford, USA)]. Light scattering is measured at 632.8 nm at 15 angles between 32° and 144° (DAWN DSP-F, Wyatt Technologies, Santa Barbara, USA). UV absorption is measured at 280 nm (CD-1595, Jasco, de Meern, The Netherlands) to detect proteins. The specific viscosity was measured with a viscosity detector (ViscoStar, Wyatt Technologies, Santa Barbara, USA) at 35° C. and sample concentration is measured by refractive index detection (λ=690 nm), held at a fixed temperature of 35° C. (ERC-7510, Erma Optical Works, Tokyo, Japan). During the analysis with SEC the polysaccharide peak is collected (2 min×0.5 mL/min=1 mL). The acid hydrolyses of the collected polysaccharide is carried out for 75 min at 120° C. with 2 M trifluoro acetic acid under nitrogen. After hydrolyses, the solution is dried overnight under vacuum and dissolved in water. High Performance Anion Exchange Chromatography with Pulsed Amperometric Detection (HPAEC-PAD) on a gold electrode was used for the quantitative analyses of the monosaccharides rhamnose, galactosamine, arabinose, glucosamine, galactose, glucose, mannose, xylose, galacturonic acid, and glucuronic acid. The analyses are performed with a 600E System controller pump (Waters, Milford, USA) with a helium degassing unit and a model 400 EC detector (EG&G, Albuquerque, USA). With a 717 autosampler (Waters, Milford, USA), 20 μl of the sample is injected on a Dionex Carbopac PA-1, 250×4 mm (10-32), column thermostated at 30° C. The monosaccharides are eluted at a flow rate of 1.0 mL/min. The monosaccharides are eluted isocratic with 16 mM sodium hydroxide followed by the elution of the acid monosaccharides starting at 20 min with a linear gradient to 200 mM sodium hydroxide+500 mM sodium acetate in 20 minutes. Data analysis is performed with Dionex Chromeleon software version 6.80. Quantitative analyses are carried out using standard solutions of the monosaccharides (Sigma-Aldrich, St. Louis, USA).

In any method, use or bacterium according to the invention, a bacterium may be any bacterium. Preferably, the bacterium is a probiotic bacterium. More preferably, the probiotic bacterium is a bacterium selected from the group consisting of the genera of Lactobacillus, Lactococcus, Leuconostoc, Carnobacterium, Streptococcus, Bifidobacterium, Bacteroides, Eubacterium, Clostridium, Fusobacterium, Propionibacterium, Enterococcus, Staphylococcus, Peptostreptococcus, and Escherichia, preferably consisting of Lactobacillus and Bifidobacterium. Preferred species of Lactobacillus and Bifidobacterium are L. reuteri, L. fermentum, L. acidophilus, L. crispatus, L. gasseri, L. johnsonii, L. plantarum, L. paracasei, L. murinus, L. jensenii, L. salivarius, L. minutis, L. brevis, L. gallinarum, L. amylovorus, B. bifidum, B. longum, B. infantis, B. breve, B. adolescente, B. animalis, B. gallinarum, B. magnum, and B. thermophilum. The Lactobacillus bacterium is preferably Lactobacillus plantarum, more preferably a Lactobacillus plantarum from the group consisting of Lactobacillus plantarum JDM1, ST-III, F9UP33, EITR17, D7V971 (ATCC14917) and C6VQ24 and most preferably Lactobacillus plantarum WCFS1. Lactobacillus plantarum WCFS1 has been deposit at the CBS in Baarn, the Netherlands under deposit number CBS113118 and is available to the person skilled in the art.

In any method according to the invention, the population of bacteria can be provided by any means or combination of means, it can e.g. be isolated from nature or it can be isolated from a food product, a culture etc.

A population of bacteria is herein defined as at least one bacterium, preferably of the same genus and species. Preferably, in the methods according to the invention, the population of bacteria comprises a bacterium selected from the group consisting of the genera of Lactobacillus and Bifidobacterium.

Culture of the population of bacteria can be performed in any culture broth known to the person skilled in the art. Preferably, the culture conditions applied to the population of bacteria differ from standard conditions in that the culture broth comprises less salt compared to standard culture conditions.

Standard culture conditions are herein defined as a culture broth, preferably 2×CDM with 1.5% glucose (Teusink, B., van Enckevort, F. H., Francke, C., Wiersma, A., Wegkamp, A., Smid, E. J., and Siezen, R. J. (2005). In silico reconstruction of the metabolic pathways of Lactobacillus plantarum: comparing predictions of nutrient requirements with those from growth experiments. Appl Environ Microbiol 71, 7253-7262) and added to it 300 mM NaCl+/−20 mM NaCl, thus from 280 mM to 320 mM NaCl. Standard culture conditions further preferably comprise anaerobic conditions at 37° C., at pH 5.8. The temperature may be varied at any temperature such as between 15 and 42° C. The pH may be varied at any pH such as at a pH from 4 to 8. The culture can be performed on any scale, including but not limited to shake flask cultivation, small-scale or large-scale cultivation (including continuous, batch, fed-batch, or solid state cultivation) in laboratory or industrial fermentors.

Preferably, a culture broth in step (b) comprises less than 300 mM NaCl, more preferably less than 250 mM NaCl, even more preferably less than 200 mM NaCl, even more preferably less than 150 mM NaCl, even more preferably less than 100 mM NaCl, even more preferably less than 50 mM NaCl, even more preferably less than 25 mM NaCl, even more preferably less than 10 mM NaCl, even more preferably less than 5 mM NaCl, even more preferably less than 2 mM NaCl, even more preferably less than 1 mM NaCl and most preferably less than 0.1 mM NaCl.

The person skilled in the art knows that other salts than NaCl have equivalent properties in culture as NaCl; the use of these equivalent salts is also within the scope of any of the methods according to the invention.

In any method according to the invention, sampling of a subpopulation of bacteria can be performed by any means known to the person skilled in the art.

A subpopulation is herein defined as at least one bacterium, preferably of the same genus and species. Preferably, in any method according to the invention, a subpopulation of bacteria comprises a bacterium selected from the group consisting of the genera of Lactobacillus and Bifidobacterium.

In any method according to the invention, the expression level of the one or more polynucleotides selected from the group consisting of:
i. a polynucleotide encoding a polypeptide having at least 30% sequence identity with the amino acid sequence of SEQ ID NO: 1,
ii. a polynucleotide encoding a polypeptide having at least 30% sequence identity with the amino acid sequence of SEQ ID NO: 2, and
iii. a polynucleotide encoding a polypeptide having at least 30% sequence identity with the amino acid sequence of SEQ ID NO: 3 determined is in step (d)
   can be determined by any means known to the person skilled in the art.

“Expression” is herein defined as the process wherein a DNA region, which is operably linked to appropriate regulatory regions, such as a promoter, is transcribed into an mRNA, which is biologically active, i.e. which is capable of being translated into a protein or peptide or which is active as RNA itself. The expression level can thus inter alia be determined by measuring the RNA level or the protein level. Examples of methods for determining the expression level are e.g. transcriptional profiling, Northern blot analysis, Western blot analysis, quantitative RT-PCR, etc. A preferred method for determining the expression level is whole genome transcriptome profiling.

“Reduced expression” is herein preferably defined as an expression level of a polynucleotide in a first population of bacteria that is lower than the expression level of said polynucleotide in a second population of bacteria when measured under identical conditions, wherein said second population of bacteria has been cultured under standard culture conditions as defined herein and wherein said first population of bacteria has been cultured under conditions that differ in at least one parameter from standard culture conditions. More preferably, reduced expression is determined relative to the expression level of the polynucleotide whose expression is to be assessed in Lactobacillus plantarum WCFS1 cultured in cultured in 100 ml Chemically Defined Medium (Teusink, B., van Enckevort, F. H., Francke, C., Wiersma, A., Wegkamp, A., Smid, E. J., and Siezen, R. J. (2005). In silico reconstruction of the metabolic pathways of Lactobacillus plantarum: comparing predictions of nutrient requirements with those from growth experiments. Appl Environ Microbiol 71, 7253-7262), without shaking in a 500 ml Erlenmeyer flask, at 37° C., to OD600 of 1.0.

Preferably, with respect to the term reduced expression herein, the expression level is 2-fold lower, more preferably 3, 4, 5, 10, 20, 25, 50, 100, 250, 500, 1000-fold, 2000-fold lower and most preferably, the reduced expression is such that expression is completely absent.

In any method according to the invention, the expression level of one or more of a polynucleotides encoding a respective polypeptide having at least 30% sequence identity with the amino acid sequence of SEQ ID NO: 1, 2 or 3 may be determined. In a method according to the invention all permutations may be used. Accordingly, the expression level of a polynucleotide encoding a polypeptide having at least 30% sequence identity with the amino acid sequence of SEQ ID NO: 1 may be determined; the expression level of a polynucleotide encoding a polypeptide having at least 30% sequence identity with the amino acid sequence of SEQ ID NO: 2 may be determined; the expression level of a polynucleotide encoding a polypeptide having at least 30% sequence identity with the amino acid sequence of SEQ ID NO: 3 may be determined; the expression level of polynucleotides encoding the polypeptides having at least 30% sequence identity with the amino acid sequences of SEQ ID NO: 1 and 2 may be determined; the expression level of polynucleotides encoding the polypeptides having at least 30% sequence identity with the amino acid sequences of SEQ ID NO: 1 and 3 may be determined; the expression level of polynucleotides encoding the polypeptides having at least 30% sequence identity with the amino acid sequences of SEQ ID NO: 2 and 3 may be determined; and the expression level of polynucleotides encoding the polypeptides having at least 30% sequence identity with the amino acid sequences of SEQ ID NO: 1, 2 and 3 may be determined.

In any method, use and bacterium according to the invention, a polynucleotide encoding a polypeptide having at least 30% sequence identity with the amino acid sequence of SEQ ID NO: 1 preferably encodes a polypeptide having at least 35%, more preferably at least 40%, more preferably at least 45%, more preferably at least 50%, more preferably at least 55%, more preferably at least 60%, more preferably at least 65%, more preferably at least 70%, more preferably at least 75%, more preferably at least 80%, more preferably at least 85%, more preferably at least 90%, even more preferably at least 95%, even more preferably at least 98% and even more preferably at least 99% sequence identity with the amino acid sequence of SEQ ID NO: 1 Most preferably, an encoded polypeptide has the amino acid sequence of SEQ ID NO: 1.

In any method, use and bacterium according to the invention, a polynucleotide encoding a polypeptide having at least 30% sequence identity with the amino acid sequence of SEQ ID NO: 2 preferably encodes a polypeptide having at least 35%, more preferably at least 40%, more preferably at least 45%, more preferably at least 50%, more preferably at least 55%, more preferably at least 60%, more preferably at least 65%, more preferably at least 70%, more preferably at least 75%, more preferably at least 80%, more preferably at least 85%, more preferably at least 90%, even more preferably at least 95%, even more preferably at least 98% and even more preferably at least 99% sequence identity with the amino acid sequence of SEQ ID NO: 2 Most preferably, an encoded polypeptide has the amino acid sequence of SEQ ID NO: 2.

In any method, use and bacterium according to the invention, a polynucleotide encoding a polypeptide having at least 30% sequence identity with the amino acid sequence of SEQ ID NO: 3 preferably encodes a polypeptide having at least 35%, more preferably at least 40%, more preferably at least 45%, more preferably at least 50%, more preferably at least 55%, more preferably at least 60%, more preferably at least 65%, more preferably at least 70%, more preferably at least 75%, more preferably at least 80%, more preferably at least 85%, more preferably at least 90%, even more preferably at least 95%, even more preferably at least 98% and even more preferably at least 99% sequence identity with the amino acid sequence of SEQ ID NO: 3 Most preferably, an encoded polypeptide has the amino acid sequence of SEQ ID NO: 3.

Percentage of identity is herein preferably determined by calculating the ratio of the number of identical nucleotides/amino acids in the sequence divided by the length of the total nucleotides/amino acids minus the lengths of any gaps. DNA multiple sequence alignment was herein performed using DNAman version 4.0 using the Optimal Alignment (Full Alignment) program. The minimal length of a relevant amino acid sequence showing 30% or higher identity level should preferably be about 40 amino acids, more preferably about 50 amino acids, more preferably about 70 amino acids, more preferably about 100 amino acids, more preferably about 150 amino acids, more preferably about 250 amino acids more preferably about 300 amino acids, or longer. Preferably, the sequence identity is calculated over 50%, 60%, 70%, 80%, 90% of the sequence length and most preferably over the entire sequence of SEQ ID NO: 1, 2, or 3. A polynucleotide sequence coding for the amino acid sequences of SEQ ID NO: 1, 2 and 3 is given in SEQ ID NO: 4, 5 and 6, respectively and in SEQ ID NO: 7, 9 and 9 these polynucleotide sequences are flanked by 1 kb upstream and downstream regions.

The expression levels determined of the at least one subpopulation of bacteria are subsequently used to identify a subpopulation of bacteria wherein the expression level of one or more polynucleotides selected from the group consisting of i), ii) and iii) is reduced to obtain a bacterium exhibiting enhanced survival properties in the gastro-intestinal tract.

The identified subpopulation of bacteria can optionally be isolated and/or purified and stored for future use. The subpopulation of bacteria may be isolated and/or purified by any method known in the art. For example, the polypeptide may be recovered from the nutrient medium by conventional procedures including, but not limited to, centrifugation, filtration, extraction, spray-drying, evaporation, or precipitation.

Preferably, reduced expression is herein determined by comparing the expression level of identical populations of bacteria, wherein one population is cultured under standard conditions as described herein and another population of bacteria is cultured under culture conditions that differ from standard culture conditions in at least one parameter.

Survival properties in the gastro-intestinal is herein defined as the relative ability of a microorganism to survive in the GI tract, expressed in relative survival rate. Preferably, the relative survival rate of a population of bacteria is expressed relative to an identical population of bacteria cultured under standard culture conditions.

Enhanced survival properties is herein defined as a statistically relevant increase in survival properties as compared to a reference, as determined by means known to the person skilled in the art; preferably said reference is an identical population of bacteria cultured under standard culture conditions. Preferably, the survival properties are determined using the GI tract in vitro assay as following:

### In Vitro GI Tract Survival Assay:

Samples with OD600 of 1.0 were taken as the logarithmic phase samples while the same samples cultured for another 25 hours were took as the stationary phase samples. The same amounts of cells (cells in 1.8 ml OD600 of 1.0 cultures) were used for all samples as a starting point. The cells were spun down by 2 min centrifugation at 10000 rpm. The pellets were washed by 1.8 ml pre-warmed (37° C.) PBS and 200 μl samples were taken for plating to determine the initial plate count. Then, remaining 1.6 ml was spun down again as in the previous step. The cells were resuspended in 1.6 ml synthetic gastric juice (GJ) for 60 min at 37° C. rotating 10 rotations per minute. (Synthetic gastric juice: [53 mM NaCl, 15 mM KCl, 5 mM Na₂CO₃, 1 mM CaCl₂, 0.1 mg/ml lipase (Fluka 62301-1G-F from Aspergillus niger) and 1.2 mg/ml pepsin (Sigma P-7125 from porcine stomach); The GJ was adjusted by HCl into two pH; pH2.4 used for the logarithmic samples and pH2.3 for the stationary samples. After the pH adjustment, GJ was sterilized by 2 μm filters (Nalgene). The lipase and pepsin were added just before the treatment.

After 60 min incubation in GJ, 200 μl samples were collected again for serial dilution and plating to determine the plate count after GJ treatment. 37° C. pre-warmed NaHCO₃ was added to the GJ-treated samples in a final concentration of 10 mM to neutralize the pH to 6.5. To the neutralized samples was then added 3541 of filter-sterilized pancreatic juice (PJ) containing 85 mM NaCl, 5 mM KH₂PO₄, 2 mM Na₂HPO₄, 10 mM NaHCO₃, 30 mg/ml pancreatin (Sigma P7545 from porcine stomach; added just before the treatment) and bile acid mix (added just before the treatment). Bile acid mixture consisted of 15 mM sodium glycocholate hydrate, 6.4 mM sodium glycodeoxycholate, 11.9 mM sodium glycochenodeoxycholate, 5.1 mM taurocholic acid sodium salt hydrate, 1.8 mM sodium taurodeoxycholate hydrate and 4.9 mM sodium taurochenodeoxycholate (Govers, M. J. A., Dietary calcium and phosphate in the prevention of colorectal cancer. Mechanism and nutrition implications. 1993, University of Groningen: Groningen.). After PJ treatment for 60 min (at 37° C., rotating 10 rotations per minute), 200 μl samples were collected for plating.

The samples collected during the assay were diluted in series from 10⁻¹ to 10⁻⁶. 10 μl from diluted samples were plated on MRS plates (Difco, Surrey, UK) according to which bacteria used. Plating of diluted samples was done in triplicate. For samples after GJ and PJ treatments, undiluted samples were also plated without triplicate by applying 100 μl samples on the plates. The plates were incubated till the colonies formed at 30° C. for WCFS1 strains or at 37° C. for all other strains. The survival properties are presented as relative survival, i.e. a comparative value of the plate count obtained from samples after treatment relative to the plate count obtained from samples before treatment. It is calculated by dividing the plate count obtained from samples after treatment by the plate count obtained from samples before treatment.

In an embodiment, enhanced survival properties are determined relative to Lactobacillus plantarum WCFS1, cultured in 100 ml Chemically Defined Medium (Teusink, B., van Enckevort, F. H., Francke, C., Wiersma, A., Wegkamp, A., Smid, E. J., and Siezen, R. J. (2005). In silico reconstruction of the metabolic pathways of Lactobacillus plantarum: comparing predictions of nutrient requirements with those from growth experiments. Appl Environ Microbiol 71, 7253-7262), without shaking in a 500 ml Erlenmeyer flask, at 37° C., to OD600 of 1.0; using the GI tract in vitro assay as described earlier herein.

Preferably, in any method according to the invention, enhanced survival properties are reflected in an increase in relative survival rate of at least 1-fold, more preferably at least 2, 3, 4, 5, 10, 15, 20, 25, 30, 40, 50, 75, 100, 200, 500, 1000 and most preferably at least 2000-fold.

In a second aspect, the present invention provides a method for screening for culture conditions that provide a bacterium exhibiting enhanced survival properties in the gastro-intestinal tract, said method comprising:
a) providing a population of bacteria,
b) culturing said population of bacteria in subpopulations wherein at least one subpopulation is cultured under different culture conditions than at least one other subpopulation,
c) determining in each of said subpopulations of bacteria the expression level of one or more polynucleotides selected from the group consisting of:
   i. a polynucleotide encoding a polypeptide having at least 30% sequence identity with the amino acid sequence of SEQ ID NO: 1,
   ii. a polynucleotide encoding a polypeptide having at least 30% sequence identity with the amino acid sequence of SEQ ID NO: 2, and
   iii. a polynucleotide encoding a polypeptide having at least 30% sequence identity with the amino acid sequence of SEQ ID NO: 3,
d) identifying a subpopulation of bacteria with reduced expression of one or more polynucleotides selected from the group consisting of i), ii) and iii) and selecting the culture conditions used for obtaining said identified subpopulation.

Preferably, in addition to or instead of determining in the expression level of one or more polynucleotides selected from the group consisting of:
i. a polynucleotide encoding a polypeptide having at least 30% sequence identity with the amino acid sequence of SEQ ID NO: 1,
ii. a polynucleotide encoding a polypeptide having at least 30% sequence identity with the amino acid sequence of SEQ ID NO: 2, and
iii. a polynucleotide encoding a polypeptide having at least 30% sequence identity with the amino acid sequence of SEQ ID NO: 3,
   the composition of capsular polysaccharide (CPS) is determined from a subpopulation in (c) here above and a subpopulation is identified with a modified CPS composition and the culture conditions used for obtaining said identified subpopulation are selected. The modified CPS composition is preferably as previously described herein.

The culture conditions applied can be any culture conditions known to the person skilled in the art, as long as at least one parameter is different for each subpopulation to be analyzed. Preferably, at least one subpopulation is cultured under standard conditions as defined earlier herein. Preferably, reduced expression is determined, as described earlier herein, by comparing the expression level of one or more polynucleotides selected from the group consisting of i), ii) and iii) of the subpopulations of bacteria, wherein at least one subpopulation is cultured under standard conditions as described herein and at least one subpopulation of bacteria is cultured under culture conditions that differ from standard culture conditions in at least one parameter. The culture conditions may be varied in more than one parameter; More than one parameter may be varied simultaneously or more than one parameter may be varied consecutively. The at least one parameter that is different as compared to standard culture conditions can be any parameter, including but not limited to: salt concentration, aerobic and anaerobic fermentation, temperature, pH, concentration of nutrients such as amino acids, glucose, mannose, fatty acids, calcium soy protein, whey protein, casein, peptone, citrate, arginine, malic acid. A preferred parameter to be varied is the salt concentration, preferably the NaCl concentration.

When a subpopulation has been identified in step (d), the culture conditions applied for said subpopulation are correlated with enhanced survival properties in the gastro-intestinal tract and can be applied to produce a population of bacteria exhibiting enhanced survival properties in the gastro-intestinal tract.

In a third aspect, the present invention provides a method for modulating the expression of one or more polynucleotides selected from the group consisting of:
i. a polynucleotide encoding a polypeptide having at least 30% sequence identity with the amino acid sequence of SEQ ID NO: 1,
ii. a polynucleotide encoding a polypeptide having at least 30% sequence identity with the amino acid sequence of SEQ ID NO: 2, and
iii. a polynucleotide encoding a polypeptide having at least 30% sequence identity with the amino acid sequence of SEQ ID NO: 3,

said method comprising providing a population of bacteria, culturing said population of bacteria, wherein the culture conditions applied result in reduced expression of one or more polynucleotides selected from the group consisting of i), ii) and iii) as compared to standard culture conditions.

The method according to the third aspect of the invention can also conveniently be used to modify the CPS composition of a population of bacteria. Modified CPS composition and methods to determine CPS composition are preferably as previously described herein.

Modulation of expression is herein defined as an induced significant change in expression level and is preferably determined by measuring the expression level of one or more polynucleotides selected from the group consisting of i), ii) and iii), as described earlier herein, and comparing said expression levels to expression levels measured from an identical population of bacteria cultured under standard culture conditions as defined earlier herein.

Preferably, a culture condition applied to the population of bacteria differs from standard conditions such that the culture broth comprises less salt compared to standard culture conditions. Preferably, the culture broth comprises less than 300 mM NaCl, more preferably less than 250 mM NaCl, even more preferably less than 200 mM NaCl, even more preferably less than 150 mM NaCl, even more preferably less than 100 mM NaCl, even more preferably less than 50 mM NaCl, even more preferably less than 25 mM NaCl, even more preferably less than 10 mM NaCl, even more preferably less than 5 mM NaCl, even more preferably less than 2 mM NaCl, even more preferably less than 1 mM NaCl and most preferably less than 0.1 mM NaCl.

A bacterium exhibiting modulated expression and/or enhanced survival properties in the gastrointestinal tract can optionally be isolated and optionally purified from the culture and stored for future use. Said bacterium may be isolated and/or purified by any method known in the art. For example, said bacterium may be recovered from the nutrient medium by conventional procedures including, but not limited to, centrifugation, filtration, extraction, spray-drying, freeze-drying, evaporation, or precipitation.

In a fourth aspect, the present invention provides a method for the preparation of a bacterium exhibiting enhanced survival properties in the gastro-intestinal tract, said method comprising providing a population of bacteria, culturing said population of bacteria, wherein the culture conditions applied result in reduced expression of one or more polynucleotides selected from the group consisting of:
i. a polynucleotide encoding a polypeptide having at least 30% sequence identity with the amino acid sequence of SEQ ID NO: 1,
ii. a polynucleotide encoding a polypeptide having at least 30% sequence identity with the amino acid sequence of SEQ ID NO: 2, and
iii. a polynucleotide encoding a polypeptide having at least 30% sequence identity with the amino acid sequence of SEQ ID NO: 3, as compared to standard culture conditions,
   and/or result in a modified CPS composition as described previously herein.

Reduced expression is preferably determined as described earlier herein, i.e. by comparing the expression level of identical populations of bacteria, wherein one population is cultured under standard conditions as described herein and another population of bacteria is cultured under culture conditions that differ from standard culture conditions in at least one parameter and result in reduced expression of one or more polynucleotides selected from the group consisting of i), ii) and iii).

Preferably, the culture conditions applied to the population of bacteria differ from standard conditions such that the culture broth comprises less salt compared to standard culture conditions. Preferably, the culture broth comprises less than 300 mM NaCl, more preferably less than 250 mM NaCl, even more preferably less than 200 mM NaCl, even more preferably less than 150 mM NaCl, even more preferably less than 100 mM NaCl, even more preferably less than 50 mM NaCl, even more preferably less than 25 mM NaCl, even more preferably less than 10 mM NaCl, even more preferably less than 5 mM NaCl, even more preferably less than 2 mM NaCl, even more preferably less than 1 mM NaCl and most preferably less than 0.1 mM NaCl.

A bacterium exhibiting modulated expression and/or enhanced survival properties in the gastrointestinal tract can optionally be isolated and optionally purified from the culture and stored for future use as described earlier herein in the third aspect of the invention.

In a fifth aspect, the present invention provides a bacterium exhibiting enhanced survival properties in the gastro-intestinal tract obtainable by any one of the methods according to the first, second and fourth aspect of the present invention. Preferably, said bacterium is the directly derived product of any one of the methods according to the first, second and fourth aspect of the present invention. Preferably, said bacterium comprises a modified CPS composition as described previously herein.

In a sixth aspect, the present invention provides a bacterium, wherein said bacterium comprises a modified CPS composition as described previously herein; and/or

wherein in said bacterium the expression of one or more polynucleotides selected from the group consisting of:
i. a polynucleotide encoding a polypeptide having at least 30% sequence identity with the amino acid sequence of SEQ ID NO: 1,
ii. a polynucleotide encoding a polypeptide having at least 30% sequence identity with the amino acid sequence of SEQ ID NO: 2, and
iii. a polynucleotide encoding a polypeptide having at least 30% sequence identity with the amino acid sequence of SEQ ID NO: 3,

is reduced as compared to the expression in a parent bacterium said bacterium derives from when both bacteria are cultivated and assayed under identical conditions.

The bacterium according to the invention is preferably a probiotic bacterium as defined previously herein.

In an embodiment, the bacterium according to the invention is a bacterium wherein in said bacterium the expression of one or more polynucleotides selected from the group consisting of:
i. a polynucleotide encoding a polypeptide having at least 30% sequence identity with the amino acid sequence of SEQ ID NO: 1,
ii. a polynucleotide encoding a polypeptide having at least 30% sequence identity with the amino acid sequence of SEQ ID NO: 2, and
iii. a polynucleotide encoding a polypeptide having at least 30% sequence identity with the amino acid sequence of SEQ ID NO: 3,
   is reduced as compared to the expression in a parent bacterium said bacterium derives from when both bacteria are cultivated and assayed under identical conditions; and/or wherein said bacterium comprises a modified CPS composition as described previously herein.

Preferably, said bacterium according to the invention exhibits enhanced survival properties in the gastro-intestinal tract.

Reduced expression is preferably determined as described earlier herein. The bacterium may be any bacterium as defined earlier herein.

A bacterium according to the fifth and sixth aspect may be a non-recombinant or a recombinant bacterium. The term “recombinant” is defined herein as any genetic modification not involving naturally occurring processes and/or genetic modifications induced by subjecting the bacterial cell to random mutagenesis.

Such recombinant bacterium may be prepared by methods well known in the art. e.g., one or more polynucleotides may be added to the bacterium's genetic makeup, i.e., may be incorporated. Such incorporation of said one or more polynucleotides may be carried out using techniques well known in the art, such as using vectors. Alternatively, one or more polynucleotides may be deleted or inactivated, as further explained below. A recombinant bacterium also includes so-called “clean deletion mutants”, i.e. deletion mutants that do not contain any foreign DNA. Such clean deletion mutants may be constructed using approaches involving suicide vectors such as pUC19. Procedures for obtaining clean deletion mutants have been described by Lambert et al. (Lambert J M, Bongers R S, Kleerebezem M. Appl Environ Microbiol. 2007 February; 73(4):1126-35). Such (clean) deletion mutants may be distinguished from a naturally occurring bacterium using a PCR approach involved PCR primers in the flanking region of the mutagenised polynucleotide, as the resulting amplicon will be distinctly smaller for the mutant compared to the wild type strain.

One or more polynucleotides encoding the polypeptides having at least 30% sequence identity with the amino acid sequences of SEQ ID NO: 1, 2 or 3 may be deleted or inactivated by one or more of: deletion, insertion or mutation of the respective polynucleotide, replacement of the promoter of the polynucleotide with a weaker promoter; antisense DNA or RNA techniques; and siRNA. The deletion or inactivation of the one or more polynucleotides results in essentially non-functional proteins, or in complete absence of the polypeptides. The term “essentially non-functional proteins” as used herein means that the protein is not or only to a small extent capable of performing its natural function in the bacterium.

An amino acid sequence of a polypeptides may be altered to produce essentially non-functional protein(s). To this end, amino acid residues may be deleted, inserted or mutated, to yield a non-functional protein of interest. A mutation of the amino acid sequence is understood as an exchange of the naturally occurring amino acid at a desired position for another amino acid. Site-directed mutagenesis may be applied to, for example, alter amino acid residues in the catalytic site, amino acid residues that are important for substrate binding, cofactor binding, or binding to effector molecules, amino acid residues that are important for correct folding, or structurally important domains of the proteins. An amino acid sequence may be mutated by methods known to the person skilled in the art, including but not limited to using site-directed mutagenesis, or may alternatively be mutated using random mutagenesis, e.g., using UV irradiation of the bacterium, chemical mutagenesis methods applied to the bacterium or random PCR methods.

It is routine practice for the person skilled in the art to choose an adequate strategy to introduce a suitable modification in a polynucleotide in order to perturb expression of a functional polypeptide. For example, methods for in vitro mutagenesis are described in Sambrook et al. (Molecular cloning, A laboratory Manual, 2^{nd} ed., Cold Spring Harbor Laboratory Press, Cold Spring Harbor, N.Y., USA, 1989). Corresponding methods are also available commercially in the form of kits (e.g., Quikchange site-directed mutagenesis kit by Stratagene, La Jolla, USA). Deletion of a polynucleotide may, for example, be accomplished by the gene replacement technology that is well known to the skilled person.

In a seventh aspect, the present invention provides a method for the preparation of a food composition, said method comprising providing a population of bacteria, culturing said population of bacteria, wherein the culture conditions applied result in reduced expression of one or more polynucleotides selected from the group consisting of:
i. a polynucleotide encoding a polypeptide having at least 30% sequence identity with the amino acid sequence of SEQ ID NO: 1,
ii. a polynucleotide encoding a polypeptide having at least 30% sequence identity with the amino acid sequence of SEQ ID NO: 2, and
iii. a polynucleotide encoding a polypeptide having at least 30% sequence identity with the amino acid sequence of SEQ ID NO: 3,

as compared to standard culture conditions,

and/or wherein the culture conditions applied result in a bacterium comprising a modified CPS composition as described previously herein, as compared to standard culture conditions,

optionally isolating and/or purifying the bacterium from the culture broth and contacting the bacterium with a food composition.

Preferably, a cultured bacterium exhibit enhanced survival properties in the gastro-intestinal tract, as described earlier herein.

Reduced expression is preferably determined as described earlier herein, i.e. by comparing the expression level of identical populations of bacteria, wherein one population is cultured under standard conditions as described herein and another population of bacteria is cultured under culture conditions that differ from standard culture conditions in at least one parameter and result in reduced expression of one or more polynucleotides selected from the group consisting of i), ii) and iii).

Preferably, a culture condition applied to the population of bacteria differ from standard conditions such that the culture broth comprises less salt compared to standard culture conditions. Preferably, the culture broth comprises less than 300 mM NaCl, more preferably less than 250 mM NaCl, even more preferably less than 200 mM NaCl, even more preferably less than 150 mM NaCl, even more preferably less than 100 mM NaCl, even more preferably less than 50 mM NaCl, even more preferably less than 25 mM NaCl, even more preferably less than 10 mM NaCl, even more preferably less than 5 mM NaCl, even more preferably less than 2 mM NaCl, even more preferably less than 1 mM NaCl and most preferably less than 0.1 mM NaCl.

A preferred composition prepared according to the method of the seventh aspect of the invention is suitable for consumption by a subject, preferably a human or an animal, more preferably a human. Such compositions may be in the form of a food supplement or a food or food composition, which besides a bacterium according to the invention also contains a suitable food base. A food or food composition is herein understood to include liquids for human or animal consumption, i.e. a drink or beverage. The food or food composition may be a solid, semi-solid, semi-liquid and/or liquid food or food composition, and in particular may be a dairy product, such as a fermented dairy product, including but not limited to a yoghurt, a yoghurt-based drink or buttermilk. Such foods or food compositions may be prepared in a manner known per se, e.g. by adding a bacterium according to the invention to a suitable food or food base, in a suitable amount. In doing so, a bacterium according to the invention may be used in a manner known per se for the preparation of such fermented foods or food compositions, e.g. in a manner known per se for the preparation of fermented dairy products using probiotics bacteria. In such methods, a bacterium according to the invention may be used in addition to the micro-organism usually used, and/or may replace one or more or part of the micro-organism usually used. For example, in the preparation of fermented dairy products such as yoghurt or yoghurt-based drinks, a bacterium according to the invention may be added to or used as part of a starter culture or may be suitably added during such a fermentation.

Preferably, a food composition according to the invention will contain a bacterium according to the invention in amounts that allow for convenient (oral) administration of said bacterium according to the invention, e.g. as or in one or more doses per day or per week. In particular, the food composition may contain a unit dose of the bacterium according to the invention.

In an eight aspect, the present invention provides a food composition comprising a bacterium according to the fifth and/or sixth aspect of the invention. Said food composition is preferably the food composition as described in the seventh aspect of the invention.

In a ninth aspect, the present invention provides the use of one or more polynucleotides selected from the group consisting of:
i. a polynucleotide encoding a polypeptide having at least 30% sequence identity with the amino acid sequence of SEQ ID NO: 1,
ii. a polynucleotide encoding a polypeptide having at least 30% sequence identity with the amino acid sequence of SEQ ID NO: 2, and
iii. a polynucleotide encoding a polypeptide having at least 30% sequence identity with the amino acid sequence of SEQ ID NO: 3,
   for the screening for a bacterium exhibiting enhanced survival properties in the gastro-intestinal tract and/or for the screening for culture conditions that provide a bacterium exhibiting enhanced survival properties in the gastro-intestinal tract and/or for the control of culture conditions providing a bacterium exhibiting enhanced survival properties in the gastro-intestinal tract.

Preferably, the expression level of one or more polynucleotides selected from the group consisting of:
i. a polynucleotide encoding a polypeptide having at least 30% sequence identity with the amino acid sequence of SEQ ID NO: 1,
ii. a polynucleotide encoding a polypeptide having at least 30% sequence identity with the amino acid sequence of SEQ ID NO: 2, and
iii. a polynucleotide encoding a polypeptide having at least 30% sequence identity with the amino acid sequence of SEQ ID NO: 3,

is determined for the screening for a bacterium exhibiting enhanced survival properties in the gastro-intestinal tract and/or for the screening for culture conditions that provide a bacterium exhibiting enhanced survival properties in the gastro-intestinal tract and/or for the control of culture conditions providing a bacterium exhibiting enhanced survival properties in the gastro-intestinal tract.

The screening for a bacterium exhibiting enhanced survival properties in the gastro-intestinal tract can be performed using any method known to the person skilled in the art; preferably, the screening is performed according the methods according to the first aspect of the invention.

The screening for culture conditions that provide a bacterium exhibiting enhanced survival properties in the gastro-intestinal tract can be performed using any method known to the person skilled in the art; preferably, the screening is performed according the methods according to the second aspect of the invention.

The control of culture conditions providing a bacterium exhibiting enhanced survival properties in the gastro-intestinal tract can be performed using any method known to the person skilled in the art; preferably, the control of culture conditions is performed according the methods according to the tenth aspect of the invention.

In a tenth aspect, the present invention provides a method for controlling culture conditions providing a bacterium exhibiting enhanced survival properties in the gastro-intestinal tract, said method comprising:
a) providing a population of bacteria,
b) culturing said population of bacteria under conditions conducive to the cultivation of said bacteria,
c) determining in a sample taken from the culture the expression level of one or more polynucleotides selected from the group consisting of:
   i. a polynucleotide encoding a polypeptide having at least 30% sequence identity with the amino acid sequence of SEQ ID NO: 1,
   ii. a polynucleotide encoding a polypeptide having at least 30% sequence identity with the amino acid sequence of SEQ ID NO: 2, and
   iii. a polynucleotide encoding a polypeptide having at least 30% sequence identity with the amino acid sequence of SEQ ID NO: 3,
d) comparing the expression levels of the one or more polynucleotides selected from the group consisting of i), ii) and iii) to reference expression levels of the one or more polynucleotides selected from the group consisting of i), ii) and iii),
e) adjusting the culture conditions,
f) repeating steps c) and d).

Preferably, in addition to or instead of determining in the expression level of one or more polynucleotides selected from the group consisting of:
i. a polynucleotide encoding a polypeptide having at least 30% sequence identity with the amino acid sequence of SEQ ID NO: 1,
ii. a polynucleotide encoding a polypeptide having at least 30% sequence identity with the amino acid sequence of SEQ ID NO: 2, and
iii. a polynucleotide encoding a polypeptide having at least 30% sequence identity with the amino acid sequence of SEQ ID NO: 3,
   the composition of the capsular polysaccharide (CPS) is determined from the sample of (c) here above and culture conditions are adjusted to achieve a modified CPS composition as described earlier herein. These alternative steps c-e may be repeated.

Preferably, the culture conditions are adjusted by at least varying a salt concentration of the culture. Preferably, a salt concentration is adjusted such that the culture broth comprises less than 300 mM NaCl, more preferably less than 250 mM NaCl, even more preferably less than 200 mM NaCl, even more preferably less than 150 mM NaCl, even more preferably less than 100 mM NaCl, even more preferably less than 50 mM NaCl, even more preferably less than 25 mM NaCl, even more preferably less than 10 mM NaCl, even more preferably less than 5 mM NaCl, even more preferably less than 2 mM NaCl, even more preferably less than 1 mM NaCl and most preferably less than 0.1 mM NaCl. Preferably, a salt concentration is adjusted such that the salt concentration remains within a range of at most +/−20% within at least 50% of the culture time. As stated previously herein, the person skilled in the art knows that other salts than NaCl have equivalent properties in culture as NaCl; the use of these equivalent salts is also within the scope of any of the methods according to the invention.

A method according to this aspect of the invention can conveniently be used to adjust the culture conditions one or more times during the culture of the bacterium, such that the desired enhanced survival properties in the gastro-intestinal tract are obtained. The method can also be conveniently used to adjust the culture conditions one or more times during the culture of the bacterium, such that the desired enhanced survival properties in the gastro-intestinal tract are obtained in a . . . way between different cultures batches.

In addition, it has now been demonstrated that reduced expression of one or more polynucleotides encoding a polypeptide having at least 30% sequence identity with the amino acid sequence of either SEQ ID NO: 1, 2 or 3 correlates with enhanced survival properties in the gastro-intestinal tract and also correlates with enhanced robustness during processing, preferably downstream processing of probiotics bacteria.

In an aspect, the present invention relates to the following preferred embodiments:
1. A method for screening for a bacterium exhibiting enhanced survival properties in the gastro-intestinal tract, said method comprising:
   a) providing a population of bacteria,
   b) culturing said population of bacteria,
   c) sampling at least one subpopulation of bacteria from said culture,
   d) determining in said subpopulation of bacteria the expression level of one or more polynucleotides selected from the group consisting of:
      i. a polynucleotide encoding a polypeptide having at least 30% sequence identity with the amino acid sequence of SEQ ID NO: 1,
      ii. a polynucleotide encoding a polypeptide having at least 30% sequence identity with the amino acid sequence of SEQ ID NO: 2, and
      iii. a polynucleotide encoding a polypeptide having at least 30% sequence identity with the amino acid sequence of SEQ ID NO: 3,
   e) identifying a subpopulation of bacteria with reduced expression of one or more polynucleotides selected from the group consisting of i), ii) and iii), and optionally isolating and/or purifying said identified subpopulation to obtain a bacterium with enhanced survival properties in the gastro-intestinal tract.
2. A method according to embodiment 1, wherein in step b) the culture conditions applied differ from standard conditions in that the culture broth comprises less salt compared to standard culture conditions.
3. A method for screening for culture conditions that provide a bacterium exhibiting enhanced survival properties in the gastro-intestinal tract, said method comprising:
   a) providing a population of bacteria,
   b) culturing said population of bacteria in subpopulations wherein at least one subpopulation is cultured under different culture conditions than at least one other subpopulation,
   c) determining in each of said subpopulations of bacteria the expression level of one or more polynucleotides selected from the group consisting of:
      i. a polynucleotide encoding a polypeptide having at least 30% sequence identity with the amino acid sequence of SEQ ID NO: 1,
      ii. a polynucleotide encoding a polypeptide having at least 30% sequence identity with the amino acid sequence of SEQ ID NO: 2, and
      iii. a polynucleotide encoding a polypeptide having at least 30% sequence identity with the amino acid sequence of SEQ ID NO: 3,
   d) identifying a subpopulation of bacteria with reduced expression of one or more polynucleotides selected from the group consisting of i), ii) and iii) and selecting the culture conditions used for obtaining said identified subpopulation.
4. A method for modulating the expression of one or more polynucleotides selected from the group consisting of:
   i. a polynucleotide encoding a polypeptide having at least 30% sequence identity with the amino acid sequence of SEQ ID NO: 1,
   ii. a polynucleotide encoding a polypeptide having at least 30% sequence identity with the amino acid sequence of SEQ ID NO: 2, and
   iii. a polynucleotide encoding a polypeptide having at least 30% sequence identity with the amino acid sequence of SEQ ID NO: 3,
   said method comprising providing a population of bacteria, culturing said population of bacteria,
   wherein the culture conditions applied result in reduced expression of one or more polynucleotides selected from the group consisting of i), ii) and iii) as compared to standard culture conditions.
5. A method for the preparation of a bacterium exhibiting enhanced survival properties in the gastro-intestinal tract, said method comprising providing a population of bacteria, culturing said population of bacteria, wherein the culture conditions applied result in reduced expression of one or more polynucleotides selected from the group consisting of:
   i. a polynucleotide encoding a polypeptide having at least 30% sequence identity with the amino acid sequence of SEQ ID NO: 1,
   ii. a polynucleotide encoding a polypeptide having at least 30% sequence identity with the amino acid sequence of SEQ ID NO: 2, and
   iii. a polynucleotide encoding a polypeptide having at least 30% sequence identity with the amino acid sequence of SEQ ID NO: 3,
   as compared to standard culture conditions.
6. A method according to embodiment 4 or 5, wherein a bacterium exhibiting modulated expression and/or enhanced survival properties in the gastrointestinal tract is isolated from the culture and is optionally purified.
7. A bacterium exhibiting enhanced survival properties in the gastro-intestinal tract obtainable by the method according to any one of embodiments 1, 2 and 4-6.
8. A bacterium, wherein in said bacterium the expression of one or more polynucleotides selected from the group consisting of:
   i. a polynucleotide encoding a polypeptide having at least 30% sequence identity with the amino acid sequence of SEQ ID NO: 1,
   ii. a polynucleotide encoding a polypeptide having at least 30% sequence identity with the amino acid sequence of SEQ ID NO: 2, and
   iii. a polynucleotide encoding a polypeptide having at least 30% sequence identity with the amino acid sequence of SEQ ID NO: 3,
   is reduced as compared to the expression in a parent bacterium said bacterium derives from when both bacteria are cultivated and assayed under identical conditions.
9. A method for the preparation of a food composition, said method comprising providing a population of bacteria, culturing said population of bacteria, wherein the culture conditions applied result in reduced expression of one or more polynucleotides selected from the group consisting of:
   i. a polynucleotide encoding a polypeptide having at least 30% sequence identity with the amino acid sequence of SEQ ID NO: 1,
   ii. a polynucleotide encoding a polypeptide having at least 30% sequence identity with the amino acid sequence of SEQ ID NO: 2, and
   iii. a polynucleotide encoding a polypeptide having at least 30% sequence identity with the amino acid sequence of SEQ ID NO: 3,
   as compared to standard culture conditions, optionally isolating and/or purifying the bacterium from the culture broth and contacting the bacterium with a food composition.
10. A food composition comprising a bacterium according to embodiment 7 or embodiment 8.
11. A method according to any one of embodiments 4, 5 or 9, wherein the culture conditions applied differ from standard conditions in that the culture broth comprises less salt compared standard culture conditions.
12. Use of one or more polynucleotides selected from the group consisting of:
   i. a polynucleotide encoding a polypeptide having at least 30% sequence identity with the amino acid sequence of SEQ ID NO: 1,
   ii. a polynucleotide encoding a polypeptide having at least 30% sequence identity with the amino acid sequence of SEQ ID NO: 2, and
   iii. a polynucleotide encoding a polypeptide having at least 30% sequence identity with the amino acid sequence of SEQ ID NO: 3,
   for the screening for a bacterium exhibiting enhanced survival properties in the gastro-intestinal tract and/or for the screening for culture conditions that provide a bacterium exhibiting enhanced survival properties in the gastro-intestinal tract and/or for the control of culture conditions providing a bacterium exhibiting enhanced survival properties in the gastro-intestinal tract.
13. Use according to embodiment 12, wherein the expression level of one or more polynucleotides selected from the group consisting of:
   i. a polynucleotide encoding a polypeptide having at least 30% sequence identity with the amino acid sequence of SEQ ID NO: 1,
   ii. a polynucleotide encoding a polypeptide having at least 30% sequence identity with the amino acid sequence of SEQ ID NO: 2, and
   iii. a polynucleotide encoding a polypeptide having at least 30% sequence identity with the amino acid sequence of SEQ ID NO: 3,
   is determined for the screening for a bacterium exhibiting enhanced survival properties in the gastro-intestinal tract and/or for the screening for culture conditions that provide a bacterium exhibiting enhanced survival properties in the gastro-intestinal tract and/or for the control of culture conditions providing a bacterium exhibiting enhanced survival properties in the gastro-intestinal tract.
14. A method for controlling culture conditions providing a bacterium exhibiting enhanced survival properties in the gastro-intestinal tract, said method comprising:
   a) providing a population of bacteria,
   b) culturing said population of bacteria under conditions conducive to the cultivation of said bacteria,
   c) determining in a sample taken from the culture the expression level of one or more polynucleotides selected from the group consisting of:
      i. a polynucleotide encoding a polypeptide having at least 30% sequence identity with the amino acid sequence of SEQ ID NO: 1,
      ii. a polynucleotide encoding a polypeptide having at least 30% sequence identity with the amino acid sequence of SEQ ID NO: 2, and
      iii. a polynucleotide encoding a polypeptide having at least 30% sequence identity with the amino acid sequence of SEQ ID NO: 3,
   d) comparing the expression levels of the one or more polynucleotides selected from the group consisting of i), ii) and iii) to reference expression levels of the one or more polynucleotides selected from the group consisting of i), ii) and iii),
   e) adjusting the culture conditions,
   f) repeating steps c) and d).
15. A method according to embodiment 14, wherein in step e), the culture conditions are adjusted by varying the salt concentration of the culture.

In this document and in its claims, the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there be one and only one of the elements. The indefinite article “a” or “an” thus usually means “at least one”. The word “about” or “approximately” when used in association with a numerical value (about 10) preferably means that the value may be the given value of 10 more or less 0.1% of the value.

The sequence information as provided herein should not be so narrowly construed as to require inclusion of erroneously identified bases. The skilled person is capable of identifying such erroneously identified bases and knows how to correct for such errors. In case of sequence errors, the sequence of the polypeptide obtainable by expression of the gene present in the Lactobacillus plantarum strain WCSF1 containing the nucleic acid sequence coding for the polypeptide should prevail.

All patent and literature references cited in the present specification are hereby incorporated by reference in their entirety.

Unless otherwise indicated each embodiment as described herein may be combined with another embodiment as described herein.

### FIGURE LEGENDS

FIG. 1. Gene-deletion mutants constructing strategy. Mutagenesis plasmids were constructed by introducing a DNA fragment containing upstream (LF), downstream (RF) homologous regions and chloramphenicol resistant (cat) gene into pNZ5319. A double cross-over homologous recombination event leads to the target gene being replaced by the cat marker, resulting in a deletion mutants.

FIG. 2. Splicing by overlap extension (SOE) method. Upstream (LF) and downstream (RF) homologous regions flanking the target gene were amplified by primers designed with overhang regions (orange parts) consisting of cat sequences (step1). The amplified fragments of LF and RF were combined with cat fragment to act as template in a second PCR reaction using the 5′ primer of LF and 3′ primer of RF to perform the SOE (step2 and 3), resulting in a SOE product containing the LF, cat and RF fragment (step4).

FIG. 3. Details of cat fragment. Cat gene is the chloramphenicol resistant marker; Tag is a unique 42-nucleotide sequence introduced into each mutant. Lox66 and lox71 are two loxP-derived recombinase recognition sites. Cre recombinase, a site-specific recombinase, catalyzes the recombination of lox66 and lox71 into lox72 and removes the cat gene, resulting in a tagged, clean deletion mutant.

FIG. 4. A) PCR products of upstream (L) and downstream (R) fragments were analyzed on 1% agarose gel. Both LF and RF were 1 kb-nucleotide fragments. B) 3.2 kb SOE products of the deletion mutants. (PstI digested λ DNA was used as ladder.—is the negative control of PCR reaction.) C) SwaI and Ecl13611 digested pNZ5319. The desired 2.7 kb was purified from the gel and used as vector for the deletion mutants.

FIG. 5. Confirmation of mutagenesis plasmids by XhoI digestion. The correct plasmids gave 5.7 kb bands while the original pNZ5319 gave 3.7 kb which served as a negative control.

FIG. 6. PCR confirmations of WCFS1 double crossing over colonies. The double crossing over colonies lack the ery resistance marker, while containing the cat gene. The correct double cross over integrations into the genome were confirmed by LF and RF PCR reactions. pNZ5319 was used for ery and cm positive controls. Negative controls for each PCR reactions were also included. The corresponding sizes of the PCR products were labeled in the lower right box.

FIG. 7. Survival results of WCFS1 deletion mutants; * show significant increase in survival, p-value<0.01, of ANOVA analysis.

### SEQUENCES

TABLE 1
Sequences as set forth in the Sequence Listing

| SEQ ID NO: | SEQ | Gene |
|---|---|---|
| 1 | Polypeptide | Lactobacillus plantarum ppb2A |
| 2 | Polypeptide | Lactobacillus plantarum Lp_1669 |
| 3 | Polypeptide | Lactobacillus plantarum napA3 |
| 4 | CDS | Lactobacillus plantarum ppb2A |
| 5 | CDS | Lactobacillus plantarum Lp_1669 |
| 6 | CDS | Lactobacillus plantarum napA3 |
| 7 | gDNA | Lactobacillus plantarum ppb2A |
| 8 | gDNA | Lactobacillus plantarum Lp_1669 |
| 9 | gDNA | Lactobacillus plantarum napA3 |
| 10 | PCR primer | Artificial sequence |
| 11 | PCR primer | Artificial sequence |
| 12 | PCR primer | Artificial sequence |
| 13 | PCR primer | Artificial sequence |
| 14 | PCR primer | Artificial sequence |
| 15 | PCR primer | Artificial sequence |
| 16 | PCR primer | Artificial sequence |
| 17 | PCR primer | Artificial sequence |
| 18 | PCR primer | Artificial sequence |
| 19 | PCR primer | Artificial sequence |
| 20 | PCR primer | Artificial sequence |
| 21 | PCR primer | Artificial sequence |
| 22 | PCR primer | Artificial sequence |
| 23 | PCR primer | Artificial sequence |
| 24 | PCR primer | Artificial sequence |
| 25 | PCR primer | Artificial sequence |
| 26 | PCR primer | Artificial sequence |
| 27 | PCR primer | Artificial sequence |
| 28 | PCR primer | Artificial sequence |
| 29 | PCR primer | Artificial sequence |
| 30 | PCR primer | Artificial sequence |
| 31 | PCR primer | Artificial sequence |
| 32 | PCR primer | Artificial sequence |
| 33 | PCR primer | Artificial sequence |
| 34 | PCR primer | Artificial sequence |
| 35 | PCR primer | Artificial sequence |
| 36 | PCR primer | Artificial sequence |
| 37 | PCR primer | Artificial sequence |
| 38 | PCR primer | Artificial sequence |
| 39 | PCR primer | Artificial sequence |
| 40 | PCR primer | Artificial sequence |
| 41 | PCR primer | Artificial sequence |
| 42 | PCR primer | Artificial sequence |
| 43 | PCR primer | Artificial sequence |
| 44 | PCR primer | Artificial sequence |
| 45 | PCR primer | Artificial sequence |
| 46 | PCR primer | Artificial sequence |
| 47 | PCR primer | Artificial sequence |
| 48 | PCR primer | Artificial sequence |
| 49 | PCR primer | Artificial sequence |
| 50 | PCR primer | Artificial sequence |
| 51 | PCR primer | Artificial sequence |
| 52 | PCR primer | Artificial sequence |
| 53 | PCR primer | Artificial sequence |
| 54 | PCR primer | Artificial sequence |
| 55 | PCR primer | Artificial sequence |
| 56 | PCR primer | Artificial sequence |
| 57 | PCR primer | Artificial sequence |
| 58 | PCR primer | Artificial sequence |
| 59 | PCR primer | Artificial sequence |
| 60 | PCR primer | Artificial sequence |
| 61 | PCR primer | Artificial sequence |
| 62 | PCR primer | Artificial sequence |
| 63 | PCR primer | Artificial sequence |
| 64 | PCR primer | Artificial sequence |
| 65 | PCR primer | Artificial sequence |
| 66 | PCR primer | Artificial sequence |
| 67 | PCR primer | Artificial sequence |
| 68 | PCR primer | Artificial sequence |
| 69 | PCR primer | Artificial sequence |
| 70 | PCR primer | Artificial sequence |
| 71 | PCR primer | Artificial sequence |
| 72 | PCR primer | Artificial sequence |
| 73 | PCR primer | Artificial sequence |
| 74 | PCR primer | Artificial sequence |
| 75 | PCR primer | Artificial sequence |
| 76 | PCR primer | Artificial sequence |
| 77 | PCR primer | Artificial sequence |
| 78 | PCR primer | Artificial sequence |
| 79 | PCR primer | Artificial sequence |
| 80 | PCR primer | Artificial sequence |

The present invention is further described by the following examples which should not be construed as limiting the scope of the invention.

Unless stated otherwise, the practice of the invention will employ standard conventional methods of molecular biology, virology, microbiology or biochemistry. Such techniques are described in Sambrook et al. (1989) Molecular Cloning, A Laboratory Manual (2^{nd} edition), Cold Spring Harbor Laboratory, Cold Spring Harbor Laboratory Press; in Sambrook and Russell (2001) Molecular Cloning: A Laboratory Manual, Third Edition, Cold Spring Harbor Laboratory Press, NY; in Volumes 1 and 2 of Ausubel et al. (1994) Current Protocols in Molecular Biology, Current Protocols, USA; and in Volumes I and II of Brown (1998) Molecular Biology LabFax, Second Edition, Academic Press (UK); Oligonucleotide Synthesis (N. Gait editor); Nucleic Acid Hybridization (Hames and Higgins, eds.).

### EXAMPLES

### Example 1

### The Molecular Mechanisms Involved in the Gastrointestinal Tract Survival of Lactobacillus plantarum

### Functional-Genomics Fermentation Platform

Even one probiotic strain induces profoundly different host responses when it is harvested from different fermentation conditions. This observation incited the development of a functional-genomics fermentation platform to correlate specific molecular signatures to probiotic functional characteristics. First, L. plantarum WCFS1 was grown in different fermentation conditions varying in pH, temperature, NaCl concentration, oxygen and amino acid availability. Then the molecular profiles such as transcriptome, glycome and proteome were analyzed in the samples harvested from different fermentors. In parallel, specific probiotic functionality parameters were assessed. The correlation of molecular features and phenotypes led to the identification of potential candidate molecules responsible for the observed probiotic functionality.

We applied this functional-genomics fermentation platform to investigate the GI tract survival mechanism of L. plantarum WCFS1. Transcriptomic analysis and the in vitro GI tract survival assay were performed in the samples harvested from different fermentors. A large dynamic range of 10⁷ cfu difference was observed in the survival assays. Utilizing random forest algorithms to correlate the transcriptomic data and the survival phenotype led to the identification of ten genes that displayed high importance in the decision trees (Table 2). During the practical period described here, these candidate effector molecules were assessed by gene deletion, and the effects on gastro-intestinal survival of L. plantarum WCFS1 were assessed. Surprisingly, decreased expression of three of the candidate genes under low salt culture conditions correlated with increased survival in the GI tract.

TABLE 2
Candidate genes potentially involving in GI tract survival.

| | | Intensity | |
|---|---|---|---|
| | | with high | |
| ORF | Name | survival | Function |
| lp_1413 | pbp2A | low | transpeptidase-transglycosylase |
| | | | (penicillin binding protein 2A) |
| lp_1669 | lp_1669 | low | transcription regulator, AraC |
| | | | family |
| lp_1817 | lp_1817 | low | ribitol-5-phosphate 2-dehydro- |
| | | | genase (putative) |
| lp_3398 | pacL3 | low | cation transporting P-type ATPase |
| lp_2827 | napA3 | low | Na(+)/H(+) antiporter |
| lp_1357 | lp_1357 | high | extracellular protein, membrane- |
| | | | anchored (putative) |
| lp_2349 | hicD3 | high | L-2-hydroxyisocaproate dehydro- |
| | | | genase |
| lp_2758 | thrC | high | threonine synthase |
| lp_0148 | lp_0148 | high | ABC transporter, permease protein, |
| | | | Cobalt (or cobalamine) |
| lp_0149 | lp_0149 | high | ABC transporter, ATP-binding |
| | | | protein, Cobalt (or cobalamine) |

### Aim and Approach

Understand the molecular gastrointestinal (GI) survival mechanisms by employing Lactobacillus plantarum WCFS1

Based on the correlation of transcriptome data and survival phenotype, candidate genes were identified and here their role in GI tract survival was verified. Gene deletion mutants were constructed. Subsequently, the mutants were tested for altered survival characteristics using the in vitro GI survival assay.

### Materials and Methods

### Bacterial Strains and Growth Condition

The bacterial strains used and their growth conditions are listed in Table 3. Escherichia coli was grown at 37° C. in TY medium (Rottlander, E. and T. A. Trautner, Genetic and transfection studies with B. subtilis phage SP 50. Molecular and General Genetics MGG, 1970. 108(1): p. 47-60) with shaking. L. plantarum WCFS1 was cultured in MRS or Chemically Defined Medium (CDM) (Otto, R., et al., The relation between growth rate and electrochemical proton gradient of <i> Streptococcus cremoris</i>. FEMS Microbiology Letters, 1983. 16(1): p. 69-74. Poolman, B. and W. N. Konings, Relation of growth of Streptococcus lactis and Streptococcus cremoris to amino acid transport. J Bacteriol, 1988. 170(2): p. 700-7.) at 30 or 37° C. without shaking. Lactobacillus casei LMG6904, Lactobacillus helveticus DPC4571, and 4 Bifidobacterium strains (Bb12, HNO19, LMG13196 and LMG18899) were grown anaerobically in MRS+0.05% cysteine without shaking. Other Lactobacillus and Bifidobacterium strains were grown at 37° C. in MRS. The plates contained 1.5% agar in identical medium. For antibiotic selection, 5 μg/ml of chloramphenicol (cm) and 200 μg/ml of erythromycin (ery) were used for E. coli. For L. plantarum WCFS1, 10 μg/ml of both cm and ery were added in MRS while 80 μg/ml cm was applied in CDM when appropriate.

TABLE 3
Bacterial strains used in this work and their growth conditions

| Species and Strains | Growth condition |
|---|---|
| Escherichia coli Top10 | TY/37° C. |
| Escherichia coli E10 | TY/37° C. |
| Lactobacillus plantarum WCFS1 | MRS or CDM/30° C. or 37° C. |

### Plasmid and Primers

Plasmids and primers used in this work are listed in Tables 4 and 5, respectively. The primers are indicated by their numbers in latter parts of the report. The isolations of plasmids from E. coli were done by using JETSTAR Midiprep kit (Genomed).

TABLE 4
Plasmids used and were constructed in this work.

| Plasmid | Description | Reference |
|---|---|---|
| pNZ5319 | Not replicated in gram positive | Lambert et al. (2007) |
| | bacteria | |
| pSIP411 | Inducible expression vector | Sørvig et al. (2005) |
| pNZ3412 | Mutagenesis plasmid pbp2A | |
| pNZ3417 | Mutagenesis plasmid lp-1669 | |
| pNZ3414 | Mutagenesis plasmid lp-1817 | |
| pNZ3415 | Mutagenesis plasmid pacL3 | |
| pNZ3416 | Mutagenesis plasmid napA3 | |
| pNZ3430 | Overexpression plasmid | |
| | lp-1357 | |
| pNZ3431 | Overexpression plasmid | |
| | hicD3 | |
| pNZ3432 | Overexpression plasmid | |
| | thrC + lp-2759 | |
| pNZ3433 | Overexpression plasmid | |
| | lp-0148~0150 | |

TABLE 5
Primers used in this study.

| Number | Description | Sequence (5′ to 3′)* |
|---|---|---|
| A1 | pbp2A-outI | AGTTCTGTGCGTAGTTTGCC |
| A2 | pbp2A-1412F | TTTGCTATAATGTATTCATTAC |
| A3 | ppbp2A-1412R | gcatacattatacgaacggtagatttTTTTTGCATAATCTTCC |
| | | CCTTGTTCAGC |
| A4 | pbp2A-1414F | cggttacagcccgggcatgagTAGTAAAGCTAGCTTCTGA |
| | | ACG |
| A5 | pbp2A-1414R | GACCGTGCAAGGTACCAATC |
| A6 | pbp2A-outII | TAGTGGTCACCCGCCACACC |
| B1 | lp-1669-outI | ATCATGGCTTAATCAACAGCG |
| B2 | lp-1669-1668F | CGCCAGGCGTAATGAGTGTG |
| B3 | lp-1669-1668R-inverted cat | gcatacattatacgaacggtagatttAATCTTCACACTAATCA |
| | | CTCCTAC |
| B4 | lp-1669-1670F-inverted cat | cggttacagcccgggcatgagTAACAAGCGTTGCCGTTTA |
| | | GG |
| B5 | lp-1669-1670R | CGAAAAATTAGTTGTCATGG |
| B6 | lp-1669-outII | AAATTAGTTGTCATGGTTGG |
| C1 | lp-1817-outI | CGCGACAGAGAAGTCCAACC |
| C2 | lp-1817-1816F | TTTCGTAGACGAGTCAAAG |
| C3 | lp-1817-1816R | gcatacattatacgaacggtagatttATTTAACATCTTATGAC |
| | | CTCTTTTTC |
| C4 | lp-1817-1818F | cggttacagcccgggcatgagTAAAGACGGTAAAGCTCGT |
| | | GTTAC |
| C5 | lp-1817-1818R | ATATGATCAACTTCCTGATT |
| C6 | lp-1817-outII | CATGTACATAAGATAGATCC |
| D1 | pacL3-outI | GGTAATCATAGCAACATTAG |
| D2 | pacL3-3397F | CATACCAGGTTGTGTCACGG |
| D3 | pacL3-3397R | gcatacattatacgaacggtagatttATTCTGCATCGTTTATT |
| | | CCGTAATTCG |
| D4 | pacL3-3399F | cggttacagcccgggcatgagTAAGGATGATCAATTCAAG |
| | | TTAGTTAAAATG |
| D5 | pacL3-3399R | GTTGATTAACAAAATTACTG |
| D6 | pacL3-outII | TCAATATCATTTTCAGTTTG |
| E1 | napA3-outI | AGTCTGGGCATGCATGAAGC |
| E2 | napA3-2826F | AACGAGCAGGCCGACGAGC |
| E3 | napA3-2826R | gcatacattatacgaacggtagatttGTAATCCATTAAAAACC |
| | | TCCTAAAAAAGG |
| E4 | napA3-2828F | cggttacagcccgggcatgagTAAAGCAATTGAAAATCCC |
| | | AACTTG |
| E5 | napA3-2828R | TCCTGGGAAGTTTACGAACC |
| E6 | napA3-outII | CCGATAACTGAAGTTCTTGG |
| F1 | lp-1357-overexpression F | CCCCCTCATGAAGCAGTTCTGGTCACTAATC |
| F2 | lp-1357-overexpression R | CTAACTCTTTGTCCCGGTTGG |
| G1 | hicD3-overexpression F | CCCCCCCATGGCTCGTAAATATGGTGTGATCG |
| | | GG |
| G2 | hicD3-overexpression R | TTATGCTTGCGGTAAAACGTCC |
| H1 | thrC + lp-2759 overexpression | CCCCCTCATGAAAACACTTTATCGCAGTACC |
| | F | |
| H2 | thrC + lp-2759 overexpression | TCAGTTGAAGTAATTTTCTAGGAAAA |
| | R | |
| I1 | lp-0148~0150 overexpression | CCCCCACATGTCTCAAAACAAGCAATCCAATT |
| | F | CA |
| | | ATTCG |
| I2 | lp-0148~0150 overexpression | TTATGCCTTAAACGGATTCCAG |
| | R | |
| R20 | R20 | AATAGTTATCTATTATTTAACGGGAGG |
| R87 | R87 | GCCGACTGTACTTTCGGATCC |
| R120 | R120 | AGAACAATCAAAGCGAGAATAAGG |
| Is169 | Is169 | TTATCATATCCCGAGGACCG |
| Is6 | Primer F of erythromycin | CGATACCGTTTACGAAATTGG |
| Is7 | Primer R of erythromycin | CTTGCTCATAAGTAACGGTAC |
| Is8 | Primer F of chloramphenicol | TCAAATACAGCTTTTAGAACTGG |
| Is9 | Primer R of chloramphenicol | ATCACAAACAGAATGATGTACC |
| S1-1 | Sequencing primer F of | GCGTACTTAGCTGGCCAGCATA |
| | pSIP411 | |
| S1-2 | Sequencing primer R of | GTAATTGCTTTATCAACTGCTGC |
| | pSIP411 | |
| S2-1 | Sequencing primer 1 of | GTGACCCAAACCGGAGCCAATACTAGTG |
| | thrC + lp-2759 | |
| S2-2 | Sequencing primer 2 of | CTTAGCTGATTTTTGGGCCGGCTTCGTG |
| | thrC + lp-2759 | |
| S2-3 | Sequencing primer 3 of | ACCATACTTACAACAACTTGAACTCAACC |
| | thrC + lp-2759 | |
| S3-1 | Sequencing primer 1 of lp- | TTACATTCCAGACGTTCAAGCTGATTACC |
| | 0148~0150 | |
| S3-2 | Sequencing primer 2 of lp- | GCTTGATTCCGCAGTCCTATCCAGG |
| | 0148~0150 | |
| S3-3 | Sequencing primer 3 of lp- | GACGGCGCGATCGTCGCTAACGACCGG |
| | 0148~0150 | |
| S3-4 | Sequencing primer 4 of lp- | GATCTCTACAACGATGATTTTTGATGAAG |
| | 0148~0150 | |
| S3-5 | Sequencing primer 5 of lp- | TCGCAAAATTTGTTCAGGCTGAACGGG |
| | 0148~0150 | |

*The lower-case letters indicates the overhang sequences that homologous to the ultimate regions of the cat (chloramphenicol acetyltransferase) amplicon.

### Mutant Construction

During the practical period described here, candidate effector molecules were targeted by mutagenesis, either by overexpression or gene deletion, and the effects on gastrointestinal survival of L. plantarum WCFS1 were assessed. According to their expression levels in the high survival performers, gene-deletion or overexpression mutants were generated aiming to improve the survival characteristics. The strategy and basic principle of the mutant constructions are described below, followed by the detail procedures utilized.

### Strategy and Principle

### Construction of Gene-Deletion Mutants

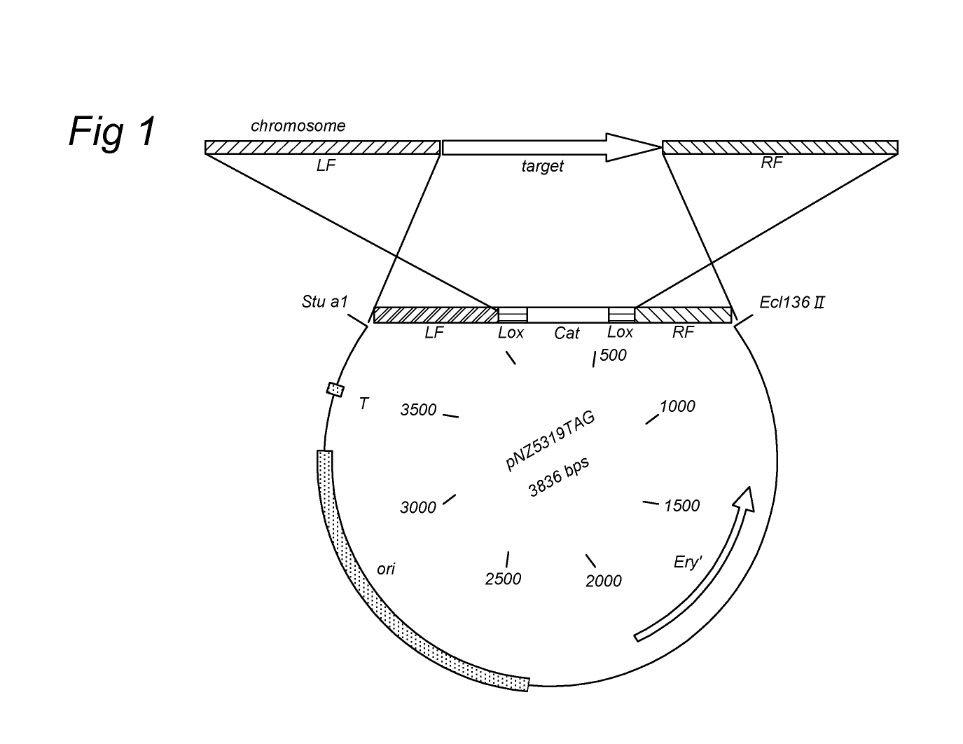

Five single-gene deletion mutants were constructed for the genes pbp2A, lp_{—}1669, lp_{—}1817, pacL3 or napA3, which all showed low expression levels in high survivors (table 1). The deletion mutants were generated by a homologous recombination-based double cross over strategy (FIG. 1). It employed a mutagenesis plasmid unable to replicate in Gram-positive bacteria (pNZ5319) which contained upstream- and downstream-flanking homologous regions of the target gene. Target genes were deleted and replaced by the Cm marker in the event of a double cross-over recombination.

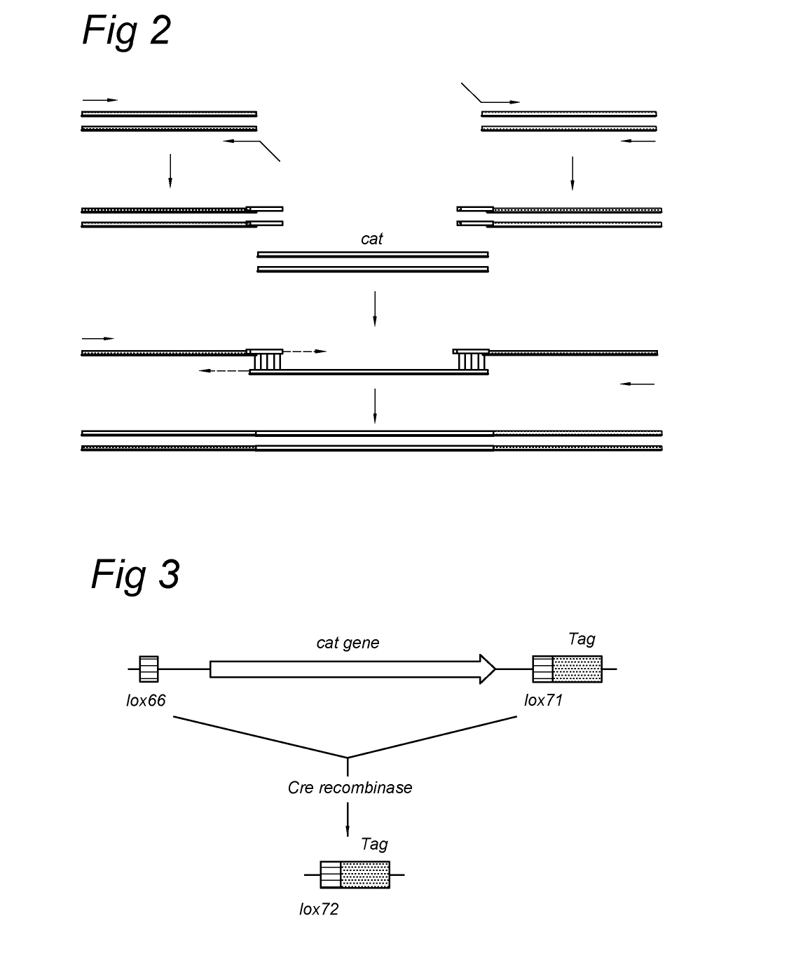

To generate a mutagenesis plasmid, the upstream- and downstream-flanking regions of the target genes were joint with the chloramphenicol resistant (cat) gene by the splicing overlap extension (SOE) method (Horton, R. M., In Vitro Recombination and Mutagenesis of DNA. 1993. p. 251-261.). The upstream and downstream flanking regions were amplified by PCR using primers containing an overhang region homologous to the ultimate 5′ and 3′ regions of the cat amplicon, respectively (FIG. 2; step1). The upstream and downstream homologous regions were combined with the cat amplicon as templates in a second PCR reaction using the 5′ primer of the upstream homologous region and the 3′ primer of the downstream homologous region, resulting in one amplicon containing all 3 initial PCR products (FIG. 2; step4). These amplicons were blunt-end ligated into the pNZ5319 vector after prior digestion with Ecl136II and SwaI. After introducing the mutagenesis plasmid into L. plantarum WCFS1, the deletion mutants were acquired by selecting double cross over transformants.

For identification purpose in future competition experiments, a tag was placed for each deletion mutant behind the cat gene (FIG. 3). Each tag contains unique 42 nucleotides which allow the quantification and detection of individual mutants in a mix culture. Considering it may be necessary to remove cat genes in certain applications, a Cre-lox-based system can be employed for removal of the chloramphenicol marker. This system was adapted from the Cre-lox recombination system to make it suitable for gram-positive bacteria. The Cre-lox-based system contains two recombinase recognition sites, lox66 and lox71, which are point-mutated variants of loxP (FIG. 3). While the recombination of lox66 and lox71 is catalyzed by a site-specific recombinase Cre enzyme, the selectable marker is removed. The recombined lox site, lox72, with double-mutants is not recognized by Cre (Lambert, J. M., R. S. Bongers, and M. Kleerebezem, Cre-lox-based system for multiple gene deletions and selectable-marker removal in Lactobacillus plantarum. Appl Environ Microbiol, 2007. 73(4): p. 1126-35.). The resulting mutant is stable and with minimized insertion of lox72 and a tag.

### Detailed Procedures

DNA manipulations were done by following the standard protocols by Sambrook [51]. All the clean-up steps for PCR products and the DNA elutions from agarose gels were done by using the Wizard® SV Gel and PCR clean up kit (Promega).

### Construction of Gene-Deletion Mutants

Five genes were selected to be deleted. First, the LF and RF were PCR-amplified by using primer pairs listed in table 6. PCR was performed by using the proof reading polymerase KOD (Novagen) and the reaction conditions were followed the recommended protocols from the supplier. The PCR products were analyzed by electrophoresis on 1% agarose gels and then were eluted from the gel. In the SOEing step, the eluted LF and RF of each mutant were combined with the cat fragments each containing a unique tag. The tag sequences were listed in table 7. During the comparison between the designed sequence and the actual sequencing result of tag 3.5, 4 nucleotide changes were found. However, this won't affect the function of the tag, as the actual sequence was still found to be unique as compared to any tag introduced into L. plantarum during gene deletion strategies employed in the multiple projects at NIZO food research The resulting SOEing products were analyzed on 1% agarose gel and the desired 3.2 kb bands were purified from the gel.

TABLE 6
Primer pairs used in LF, RF amplification and in the SOE step.

| | Target | LF primer | RF primer | SOE primer |
|---|---|---|---|---|
| Label | gene | pair | pair | pair |
| A | pbp2A | A2/A3 | A4/A5 | A2/A5 |
| B | lp-1669 | B2/B3 | B4/B5 | B2/B5 |
| C | lp-1817 | C2/C3 | C4/C5 | C2/C5 |
| D | pacL3 | D2/D3 | D4/D5 | D2/D5 |
| E | napA3 | E2/E3 | E4/E5 | E2/E5 |

TABLE 7
Unique tags for each mutant. 4 nucleotide changes were found
in tag 3.5. The different nucleotides are underlined.

| | Target | | |
|---|---|---|---|
| Label | gene | Tag | |
| A | pbp2A | 3.5 | CATACTTAGAGTGAGTCTAGGTTCCTTTCAGCCTATGAGTGT |
| B | lp-1669 | 3.6 | GTCCCTTCCAAACTTTCTTACTTGCACTCAGTGAGCCTTAGA |
| C | lp-1817 | 3.7 | CTTGCTATGTATCATACTGCCTTGGTCTCTACCTTGCTCAGA |
| D | pacL3 | 3.8 | CTAACTATGTCTCTTTCATGCATCCTTGCATTGTCTGATACT |
| E | napA3 | 4.1 | CTTTGTTTCTCTCTGTCTCTCACTGACCGTATGAAACAGTGT |

To prepare the mutagenesis backbone, pNZ5319 vector was digested by 10U of each SwaI (Biolabs) and Ecl136II (Fermentas). The restriction enzyme reactions were conducted in the conditions recommended by the commercial suppliers. The digested pNZ5319 was separated by 1% agarose gel electrophoresis. The backbone 2.7 kb fragment was excised and eluted from the gel by using the Wizard® SV Gel and PCR clean up kit (Promega).

Mutagenesis plasmids were made by blunt-ends ligation between 2.7 kb fragment from pNZ5319 and 3.2 kb SOE products. The ligations were catalyzed by T4 DNA ligase (Invitrogen) following the protocol from the supplier. The chemical transformations of the ligation mixtures into One Shot° Top10 Cells (Invitrogen) were performed as recommended by the supplier. The transformed E. coli cells were grown on TYA+5 μg/ml cm plates at 37° C. for 1 to 2 days.

Colony PCR (Sandhu, G. S., J. W. Precup, and B. C. Kline, Rapid one-step characterization of recombinant vectors by direct analysis of transformed Escherichia coli colonies. Biotechniques, 1989. 7(7): p. 689-90.) was performed to screen the colonies containing correct mutagenesis plasmids with corresponding SOE products. To eliminate false positives, the colonies from the transformations were transferred to new TYA+5 μg/ml cm plates (Josson, K., et al., Characterization of a gram-positive broad-host-range plasmid isolated from Lactobacillus hilgardii. Plasmid, 1989. 21(1): p. 9-20.) and the newly grown colonies were used for screening. The presences of SOE products were confirmed by using the forward primer of LF (primer A2, B2, C2, D2 and E2 for pbp2A, lp_{—}1669, lp_{—}1817, pacL3 and napA3 mutants, respectively) and the reverse primer Is169 that is compliment to cat fragment. PCR program was initiated with 10 min at 95° C., followed by 35 cycles of amplifications (30 sec at 95° C.-30 sec at 50° C.-1 min at 72° C.) and finished with 5 min at 72° C. The PCR mixtures were prepared from 2×PCR Master Mix (Promega) and the specific primers indicated above.

Restriction enzymes digestion patterns were used to reconfirm the presence of SOE inserts. The plasmids were isolated from the colony-PCR positive colonies and then subjected to XhoI (Invitrogen) digestion. The confirmed plasmids were sent for DNA sequencing (BaseClear B.V.) by using 4 primers (R20, R87, R120 and Is169) for each deletion mutant.

Lactobacillus plantarum WCFS1 Transformation

The sequencing verified plasmids were transformed into L. plantarum WCFS1 by electroporation. The procedures were modified from the method described by Josson et al., supra. For preparing competent cells, WCFS1 was grown in MRS at 37° C. overnight. Next day, the overnight culture was diluted with MRS+1% glycine in 10-fold series from 10⁻² to 10⁻⁸. The series-diluted cultures were incubated at 37° C. overnight. Among the overnight cultures of series-dilutions, the culture with OD600 around 2.5 was used as a pre-culture for competent cell preparation. The pre-culture was diluted 20 times in MRS+1% glycine and grew at 37° C. till OD600 was between 0.6 and 0.65. The culture was chilled on ice and harvested by centrifugation at 4° C., 4500 rpm for 10 min. The pellet was resuspended in 0.5 volume ice-cold 30% PEG-1450 followed by the centrifugation as previous step. The resulting pellet was resuspended in 0.01 volume of ice-cold 30% PEG-1450 and divided into 40 μl aliquots. These competent cells can be directly used in the transformation or be stored at −80° C.

For the transformation, 1-5 μg DNA was added to 40 μl competent cells and the mixtures were transferred into 2 mm cuvettes (Cell Projects). The electroporations were performed by a single electric pulse of 1.5kV, 25 μF and 400Ω. After the pulse, the cells were chilled on ice for 2 min, and then were transferred to eppendorf tubes. The cells were recovered in 1 ml MRS containing 0.5M sucrose and 0.1M MgCl₂ for 2 hours at 37° C. For the deletion mutants, every 100 μl of recovered cells was plated on one MRS+5 μg/ml cm plate till all cells were plated. For overexpression mutants, a 100 μl portion was plated on MRS+10 μg/ml plate. The plates were incubated at 37° C. for 2-3 days till the colonies formed.

### Screening for Desired WCFS1 Transformants

### Deletion Mutants

To screen for double crossing over transformants in the deletion mutants, the colonies formed from the WCFS1 transformations were first verified by ery sensitive and cm resistant (ery^{s}, cm^{r}) phenotype. The colonies were plated on both MRS+10 μg/ml ery plates and MRS+5 μg/ml cm plates. Those grown only on cm plates but not on ery plates were further confirmed by colony PCR. WCFS1 colonies were first treated in a microwave for 3 min at 750 W to disrupt the cells. ery gene was checked by using primer Is6 and Is7 while cm gene was confirmed with primer Is8 and Is9. The remainder of the colony PCR procedures was identical to the descriptions for E. coli above. The PCR was performed to confirm the replacements of target genes by using one primer annealed to genome and the other annealed to cat fragment. The specific primer pair for each mutant was listed in table 8.

TABLE 8
Primer pair for each mutant to confirm
the correct integration in the genome.

| Label | Target gene | Left side | Right side |
|---|---|---|---|
| A | pbp2A | A1/Is169 | R87/A6 |
| B | lp-1669 | B1/R87 | Is169/B6 |
| C | lp-1817 | C1/Is169 | R87/C6 |
| D | pacL3 | D1/Is169 | R87/D6 |
| E | napA3 | E1/Is169 | R87/E6 |

### In Vitro GI Tract Survival Assay

Samples with 1.0 of OD600 were took as the logarithmic phase samples while the same samples cultured for another 25 hours were took as the stationary phase samples. The same amounts of cells (cells in 1.8 ml of OD600 1.0 cultures) were used for all samples as a starting point. The cells were span down by 2 min centrifugation at 10000 rpm. The pellets were washed by 1.8 ml pre-warmed (37° C.) PBS and 200 μl samples were took for plating. Then, they were span down again as the previous step. The cells were resuspended in 1.6 ml the gastric juice (GJ) [53 mM NaCl, 15 mM KCl, 5 mM Na₂CO₃, 1 mM CaCl₂, 0.1 mg/ml lipase (Fluka 62301-1G-F from Aspergillus niger) and 1.2 mg/ml pepsin (Sigma P-7125 from porcine stomach)] for 60 min at 37° C. The GJ was adjusted by HCl into two pH; pH2.4 used for the logarithmic samples and pH2.3 for the stationary samples. After the pH adjustment, GJ was sterilized by 2 μm filters (Nalgene). The lipase and pepsin were added just before the treatment.

After 60 min incubation in GJ, 200 μl samples were collected again for plating. 37° C. pre-warmed NaHCO₃ was added to the GJ-treated samples in a final concentration of 10 mM to neutralize the pH to 6.5. The neutralized samples were then added with 352 μl of filter-sterilized pancreatic juice containing 85 mM NaCl, 5 mM KH₂PO₄, 2 mM Na₂HPO₄, 10 mM NaHCO₃, 30 mg/ml pancreatin (Sigma P7545 from porcine stomach; added just before the treatment) and bile acid mix (added just before the treatment). Bile acid mixture consisted of 15 mM sodium glycocholate hydrate, 6.4 mM sodium glycodeoxycholate, 11.9 mM sodium glycochenodeoxycholate, 5.1 mM taurocholic acid sodium salt hydrate, 1.8 mM sodium taurodeoxycholate hydrate and 4.9 mM sodium taurochenodeoxycholate (Govers, M. J. A., Dietary calcium and phosphate in the prevention of colorectal cancer. Mechanism and nutrition implications. 1993, University of Groningen: Groningen.). After the PJ treatment for another 60 min, the 200 μl of samples were collected for plating.

The samples collected during the assay were diluted in series from 10⁻¹ to 10⁻⁶. 10 μl from diluted samples were plated on the plates according to which bacteria used. Plating of diluted samples was done in triplicate. For samples after GJ and PJ treatments, undiluted samples were also plated without triplicate by applying 100 μl samples on the plates. The plates were incubated till the colonies formed at 30° C. for WCFS1 strains or at 37° C. for all other strains. The survival results were presented as relative survival which is a comparative value with the starting cfu counts. It was calculated by first converting the cfu counts into log values and subsequently dividing the individual log cfu with the log cfu of time point 0 to correct with the starting amounts.

For additives, 15% D-glucose and 1% whey protein were prepared as 10× solutions. L-glucose was prepared in 3% as a 2× solution. All additive solutions were prepared by dissolving the substances in RO water. After dissolving in the water, all solutions were adjusted by HCl into two different pH values: 2.4 and 2.3. The additive solutions were then sterilized by 2 μm filters and store at room temperature. During the assay, the additives were added together with the GJ.

### Statistics Analysis

Survival data were analyzed by ANOVA to compare the differences between mutants and wild type WCFS1. Data from two independent experiments were first normalized by the mean value of the corresponding experiment to eliminate the day-to-day difference. The normalized data were then used for ANOVA analysis. A significant difference was set as a p-value below 0.01.

### Results

### Construction of Deletion Mutants

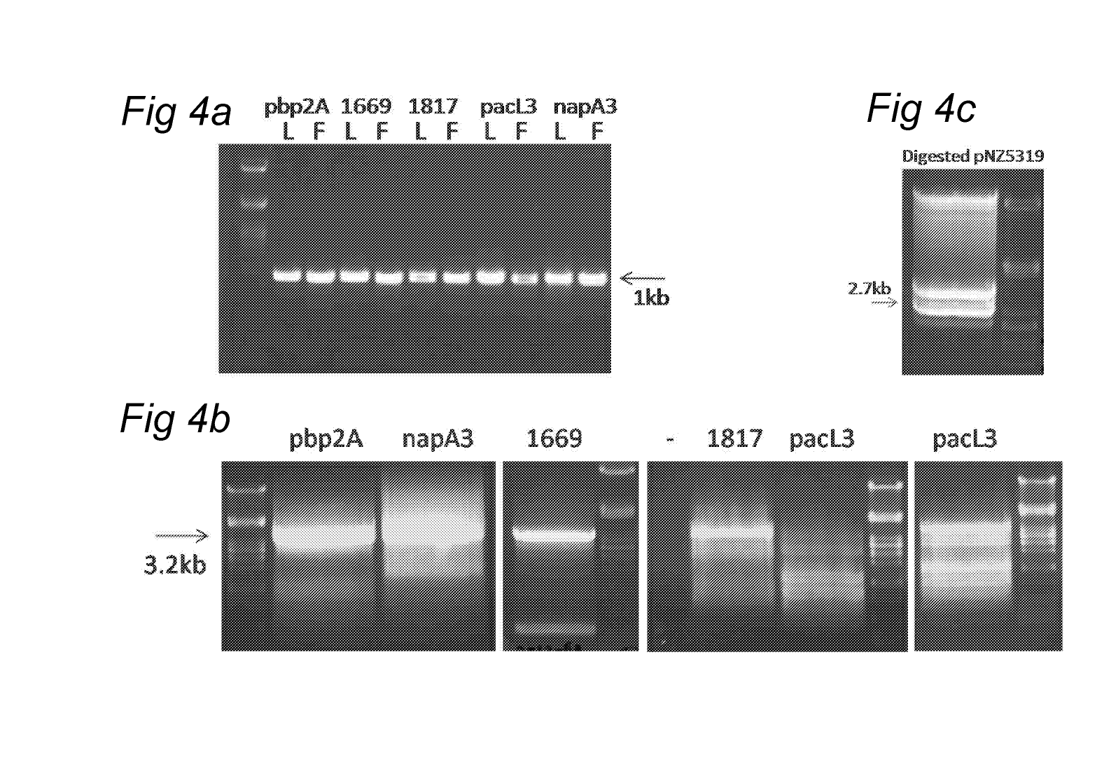

For the genes shown low expressions associated with high survival, deletion mutants were constructed aiming to further improve the survival. To construct mutagenesis plasmids, 1 kb fragments of LF and RF as well as 3.2 kb SOEing products were generated as described above (FIGS. 4A and 4B). The 3.2 kb fragments were isolated from agarose gel for later ligation steps.

The pNZ5319 vector was used as the mutagenesis plasmid backbone. It does not replicate in L. plantarum, stimulating the chromosomal homologous recombination event. The pNZ5319 vector was digested by SwaI and Ecl13611 enzymes to remove cat gene on the vector. The 2.7 kb fragment of digested pNZ5319 was isolated from agarose gel (FIG. 4C). Mutagenesis plasmids were generated by blunt-ends ligation of 3.2 kb SOE product and the 2.7 kb fragment harboring the pNZ5319 backbone. The ligation mixtures were transformed into E. coli.

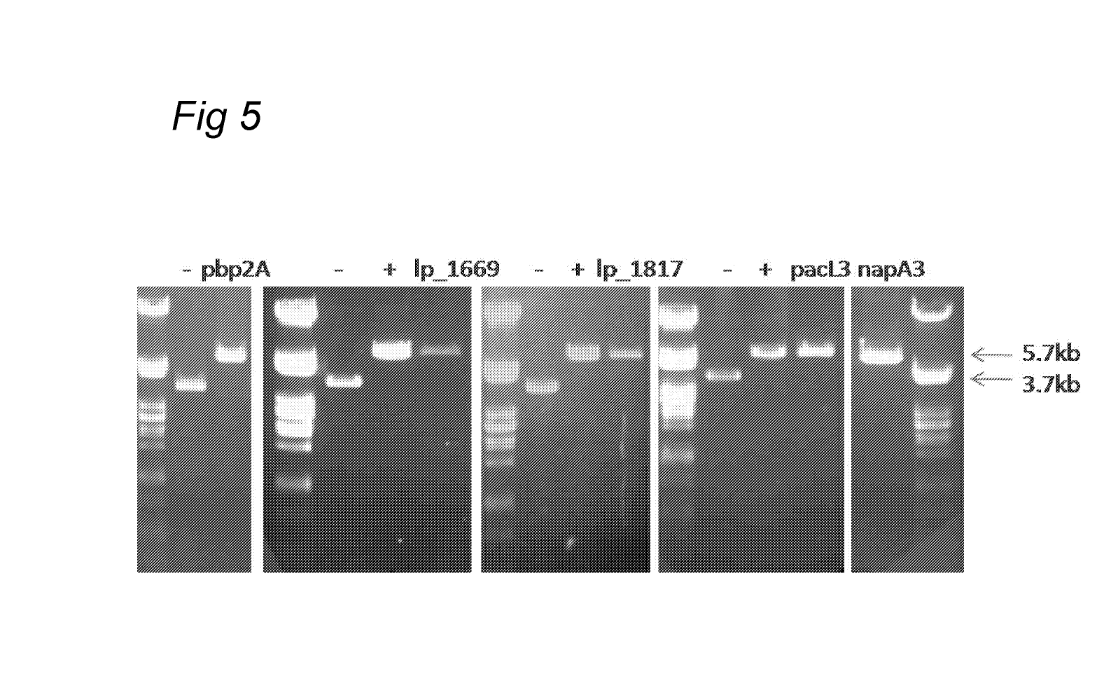

E. coli transformants were screened by colony-PCR for the presences of anticipated mutagenesis plasmids. PCR-positive clones were grown overnight in liquid medium, plasmids were isolated from the full-grown cultures and were subjected to restriction enzyme digestions. The mutagenesis plasmids were discriminated from original pNZ5319 by showing larger DNA fragments after XhoI digestions due to the presence of SOE products (FIG. 5). The mutagenesis plasmids were further confirmed by DNA sequencing which revealed the inserts were exactly as anticipated.

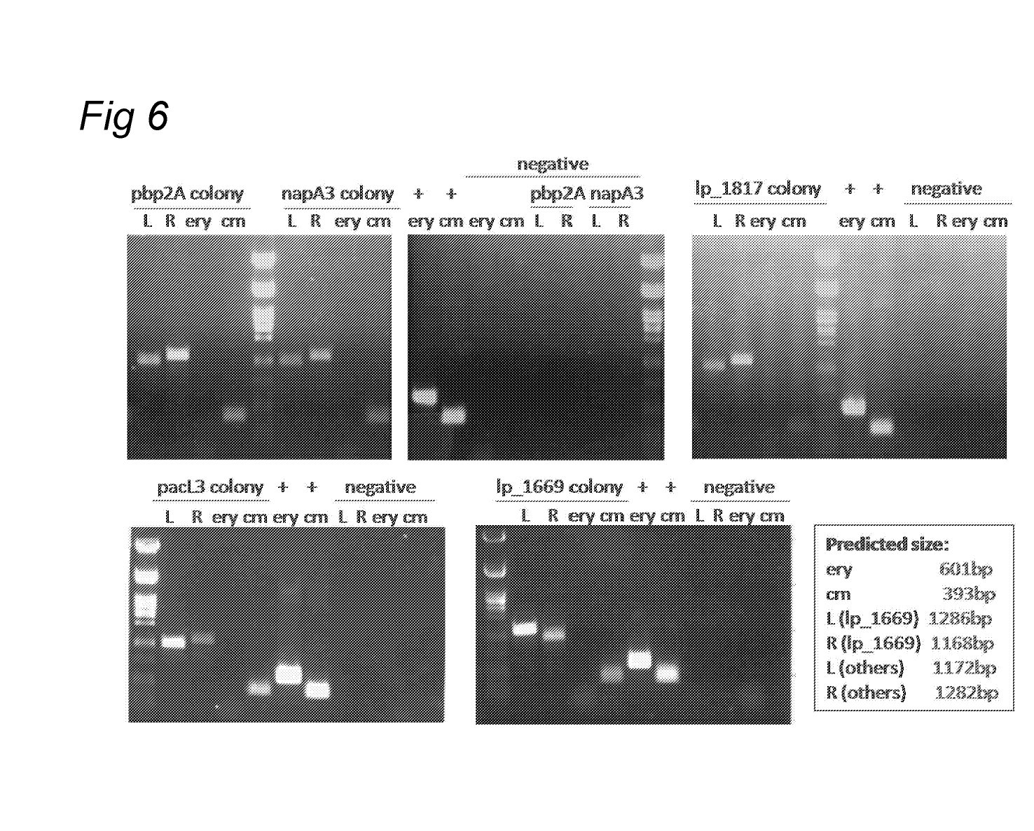

The sequence-verified mutagenesis plasmids were introduced into L. plantarum WCFS1 by electroporation. The resulting colonies were assessed for their integration event by establishment of their ery and cm phenotypes which was subsequently confirmed by PCR. In the PCR confirmation, the desired double cross over integrations of cat fragments showed 1.2 kb product in the LF reactions and 1.3 kb in the RF except lp_{—}1669 (FIG. 6). Notably, the Lp_{—}1669 mutant had the cat fragment in the opposite orientation comparing to other deletion mutants due to the fact that the E. coli cloning was unsuccessful in the initial orientation. Therefore, the LF reaction gave 1.3 kb product while RF showed a 1.2 kb band in the PCR confirmations of lp_{—}1669 (FIG. 6; lower middle). The pNZ5319 was used as positive controls for ery and cat genes generating, respectively, 601 bp and 393 bp products (FIG. 6). The cat-replacements of target genes through double crossing over were confirmed by the presence of cm and the absence of ery genes. All deletion mutants were obtained. For all mutants one colony displaying the anticipated genotype and phenotype was selected for the remainder of the research described in this thesis.

### In Vitro GI Survival of WCFS1 Mutants

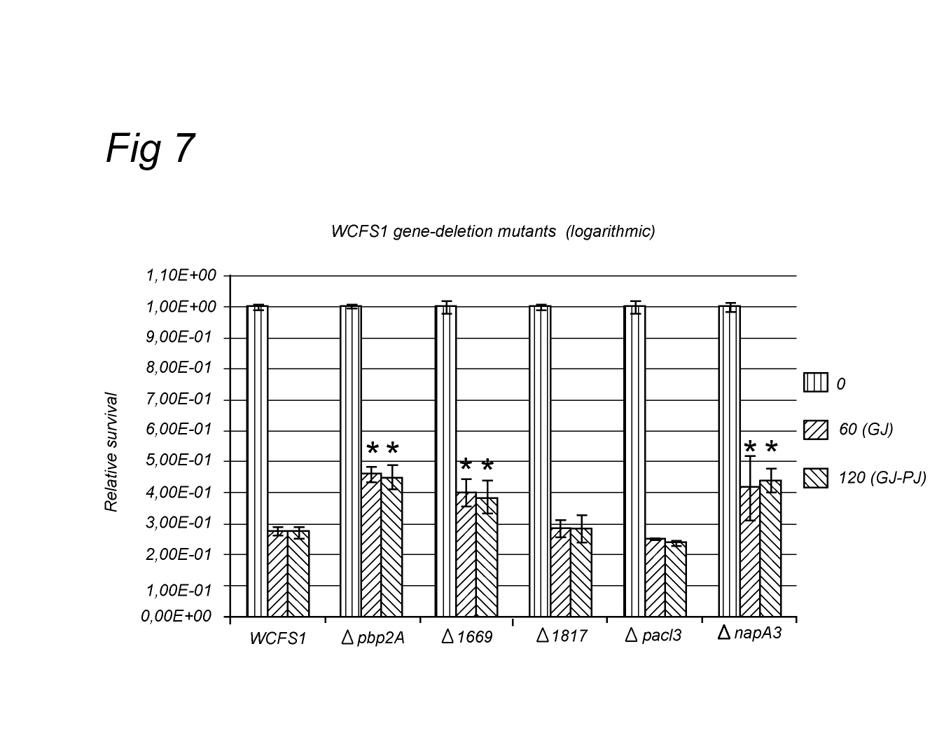

To study the survival of probiotics, an in vitro assay was developed to mimic these two important stress conditions in the GI tract. The assay included gastric challenge of low pH combined with lipase and pepsin, followed by pH neutralization and an exposure of pancreatin and bile acids. This assay was used to compare the GI tract survival of mutants with the wild-type. Constructed mutants, as well as some other L. plantarum WCFS1 mutants already available in our laboratory were tested for their survival by the in vitro GI tract assay. Several of the deletion mutants showed improved survival; and, therefore, the experiment was repeated to confirm the results. The data from these two independent experiments were analyzed by ANOVA. Although the general trends in both experiments were very similar, this statistical analysis revealed a significant day-effect. Therefore, the L. plantarum WCFS1 wild-type control was exploited to correct for the day effect between these 2 experiments. Using these corrected datasets, ANOVA analysis revealed significantly improved (p<0.01) survival for Δpbp2A, Δlp_{—}1669 and ΔnapA3 as compared to L. plantarum WCFS1 wild type (FIG. 7). These results demonstrate a clear involvement of the corresponding gene products in gastrointestinal survival.

### Discussion

### Genotype Phenotype Matching is a Powerful Tool to Explore Molecular Mechanisms

In the post-genomic era, the growing collections of genomic sequences and expression profiles open new avenues to explore molecular functions important for probiotic functionality.

Roles of pbp2A, lp_{—}1669 and napA3 in the Survival Mechanisms

Our results clearly demonstrate that the gene products of pbp2A, lp_{—}1669 and napA3 are involved in the GI tract survival mechanism in L. plantarum WCFS1, as the disruptions of these genes improved the survival.

### Example 2

### Composition of Capsular Polysaccharide (CPS) of Lactobacillus plantarum WCFS1 Δlp_{—}1669::cat

### Materials and Methods:

### Capsular Polysaccharide (CPS) Isolation and Determination

CPS was purified and chain lengths and sugar groups were determined essentially as described before (Looijesteijn et al, 1999). In short, 500 ml cultures of L. plantarum WCFS1 and NZ3417^{CM} (Δlp_{—}1669::cat) were grown in 2×CDM until stationary phase (25 h). After 1 h incubation at 55° C., the cells were separated from the CPS containing growth medium by centrifugation for 15 min (6000×g) and to prevent overgrowth during dialysis, erythromicine was added to the supernatant to a final concentration of 10 μg/ml. A dialyzing tube 12-1400 Da (Fisher Scientific) was prepared by boiling twice 2% NaHCO₃/2 mM EDTA, and once in reverse osmosis water. After overnight dialysis against running tap water followed by 4 h dialysis using reverse osmosis water, the samples were freeze-dried and stored at −20° C. until further analysis.

The samples were dissolved in eluent (in-line vacuum degassed 100 mM NaNO₃+0.02% NaN₃), filter sterilized, and placed in a thermally controlled sample holder at 10° C. and 200 μl was injected on the columns (model 231 Bio, Gilson) to perform size exclusion chromatography (SEC) [TSK gel PWXL guard column, 6.0 mm×4.0 cm, TSK gel G6000 PWXL analytical column, 7.8 mm×30 cm, 13.0 μm and TSK gel G5000 PWXL analytical column, 7.8 mm×30 cm, 10 μm (TosoHaas, King of Prussio, USA) connected in series and thermostated at 35° C. with a temperature control module (Waters, Milford, USA)]. Light scattering was measured at 632.8 nm at 15 angles between 32° and 144° (DAWN DSP-F, Wyatt Technologies, Santa Barbara, USA). UV absorption was measured at 280 nm (CD-1595, Jasco, de Meern, The Netherlands) to detect proteins. The specific viscosity was measured with a viscosity detector (ViscoStar, Wyatt Technologies, Santa Barbara, USA) at 35° C. and sample concentration was measured by refractive index detection (λ=690 nm), held at a fixed temperature of 35° C. (ERC-7510, Erma Optical Works, Tokyo, Japan). During the analysis with SEC the polysaccharide peak was collected (2 min×0.5 mL/min=1 mL). The acid hydrolyses of the collected polysaccharide was carried out for 75 min at 120° C. with 2 M trifluoro acetic acid under nitrogen. After hydrolyses, the solution was dried overnight under vacuum and dissolved in water. High Performance Anion Exchange Chromatography with Pulsed Amperometric Detection (HPAEC-PAD) on a gold electrode was used for the quantitative analyses of the monosaccharides rhamnose, galactosamine, arabinose, glucosamine, galactose, glucose, mannose, xylose, galacturonic acid, and glucuronic acid. The analyses were performed with a 600E System controller pump (Waters, Milford, USA) with a helium degassing unit and a model 400 EC detector (EG&G, Albuquerque, USA). With a 717 autosampler (Waters, Milford, USA), 20 μl of the sample was injected on a Dionex Carbopac PA-1, 250×4 mm (10-32), column thermostated at 30° C. The monosaccharides were eluted at a flow rate of 1.0 mL/min. The monosaccharides were eluted isocratic with 16 mM sodium hydroxide followed by the elution of the acid monosaccharides starting at 20 min with a linear gradient to 200 mM sodium hydroxide+500 mM sodium acetate in 20 minutes. Data analysis was done with Dionex Chromeleon software version 6.80. Quantitative analyses were carried out using standard solutions of the monosaccharides (Sigma-Aldrich, St. Louis, USA).

### Results

To elucidate the regulon associated with regulator the transcriptome profile of the NZ3417^{CM} (Δlp_{—}1669::cat) strain was compared to that of the wild-type strain grown in 2×CDM or in a standard Lactobacillus laboratory medium (MRS). Differential transcriptome datasets were mined for overrepresented (main and sub-) functional classes using the Biological Networks Gene Ontology (BiNGO) tool (Mare et al, 2005). The results showed that the Lp1669-deficient strain displayed enhanced expression of genes belonging to the main functional class of cell envelope associated functions, and more specifically to its subclass of surface polysaccharides, lipopolysaccharides, and antigens. This effect of the mutation was observed independent of the medium used (FIG. 8 and table S3 and S4). Gene-specific analysis revealed that the capsular polysaccharide (CPS) clusters cps2, cps3, and cps4 are repressed in the MRS-grown wild-type strain in a manner that depends directly or indirectly on the regulatory function encoded by Lp1669, while especially the expression of the cps2 cluster was repressed in 2×CDM grown wild-type cells (data not shown). Next to the cps2 cluster, the histidine biosynthesis gene-cluster (lp_{—}2551-2560) appeared to be repressed in the wild-type in a Lp1669 dependent manner when cells were grown in 2×CDM. To confirm the involvement of Lp1669 in CPS modification, the CPS of the NZ3417^{CM} (Δlp_{—}1669::cat) strain and the wild-type was isolated and molar mass and sugar composition were determined using HPLC according to Looijesteijn et al (1999). There are some minor changes in CPS sugar composition of the Lp1669-deficient strain compared with the wild type (table 9), as galactosamine was not detected in the wild type, while arabinose could not be detected in the mutant strain. In addition, rhamnose and glucosamine were slightly more abundant in the wild type. However, the CPS molar mass of the Δlp_{—}1669::cat strain was 1.5-fold higher compared with the wild type (table 9). This indicates that indeed Lp1669 is involved in CPS modification, specifically in chain length determination. Most likely due to the difference in CPS composition, the mutant strain survived the harsh conditions of the GI-tract assay better as compared with the wild type.

TABLE 9
Molar mass and sugar composition of CPS isolated from
L. plantarum WCFS1 and NZ3417^{CM} (Δlp_1669::cat).

| Strain | WCFS1 | Δlp_1669::cat |
|---|---|---|
| Total molar mass (kg/mol) | 20 (±1.4)^{a} | 30 (±1.5) |
| Sugar (% of total sugars)^{b} | | |
| Rhamnose | 3.2 | 2.6 |
| Galactosamine | ND | 1.3 |
| Arabinose | 0.5 | ND |
| Glucosamine | 3.7 | 2.8 |
| Galactose | 12.6 | 12.8 |
| Glucose | 27.8 | 26.4 |
| Galacturonic acid | 52.3 | 54.1 |

^{a}deviation.
^{b}ND: below detection limit

### REFERENCE LIST

1. FAO/WHO, Evaluation of health and nutritional properties of powder milk with live lactic acid bacteria. Report of FAO/WHO expert consultation 1-4 Oct. 2001.
2. Marco, M. L., S. Pavan, and M. Kleerebezem, Towards understanding molecular modes of probiotic action. Curr Opin Biotechnol, 2006. 17(2): p. 204-10.
3. Corr, S. C., C. Hill, and C. G. Gahan, Understanding the mechanisms by which probiotics inhibit gastrointestinal pathogens. Adv Food Nutr Res, 2009. 56: p. 1-15.
4. Saulnier, D. M. A., et al., Mechanisms of probiosis and prebiosis: considerations for enhanced functional foods. Current Opinion in Biotechnology, 2009. 20(2): p. 135-141.
5. Saxelin, M., et al., Probiotic and other functional microbes: from markets to mechanisms. Curr Opin Biotechnol, 2005. 16(2): p. 204-11.
6. Ma, D., P. Forsythe, and J. Bienenstock, Live Lactobacillus reuteri is essential for the inhibitory effect on tumor necrosis factor alpha-induced interleukin-8 expression. Infect Immun, 2004. 72(9): p. 5308-14.
7. Gobbetti, M., R. D. Cagno, and M. De Angelis, Functional microorganisms for functional food quality. Crit Rev Food Sci Nutr, 2010. 50(8): p. 716-27.
8. Corcoran, B. M., et al., Life under stress: The probiotic stress response and how it may be manipulated. Current Pharmaceutical Design, 2008. 14(14): p. 1382-1399.
9. van de Guchte, M., et al., Stress responses in lactic acid bacteria. Antonie Van Leeuwenhoek, 2002. 82(1-4): p. 187-216.
10. Watson, D., et al., Enhancing bile tolerance improves survival and persistence of Bifidobacterium and Lactococcus in the murine gastrointestinal tract. BMC Microbiol, 2008. 8: p. 176.
11. Begley, M., C. G. Gahan, and C. Hill, The interaction between bacteria and bile. FEMS Microbiol Rev, 2005. 29(4): p. 625-51.
12. Govers, M. J. A., Dietary calcium and phosphate in the prevention of colorectal cancer. Mechanism and nutrition implications. 1993, University of Groningen: Groningen.
13. Rottlander, E. and T. A. Trautner, Genetic and transfection studies with B. subtilis phage SP 50. Molecular and General Genetics MGG, 1970. 108(1): p. 47-60
14. Otto, R., et al., The relation between growth rate and electrochemical proton gradient of <i>Streptococcus cremoris</i>. FEMS Microbiology Letters, 1983. 16(1): p. 69-74.
15. Poolman, B. and W. N. Konings, Relation of growth of Streptococcus lactis and Streptococcus cremoris to amino acid transport. J Bacteriol, 1988. 170(2): p. 700-7.
16. Horton, R. M., In Vitro Recombination and Mutagenesis of DNA. 1993. p. 251-261.
17. Teusink, B., van Enckevort, F. H., Francke, C., Wiersma, A., Wegkamp, A., Smid, E. J., and Siezen, R. J. (2005). In silico reconstruction of the metabolic pathways of Lactobacillus plantarum: comparing predictions of nutrient requirements with those from growth experiments. Appl Environ Microbiol 71, 7253-7262
18. Lambert, J. M., R. S. Bongers, and M. Kleerebezem, Cre-lox-based system for multiple gene deletions and selectable-marker removal in Lactobacillus plantarum. Appl Environ Microbiol, 2007. 73(4): p. 1126-35.
19. Sandhu, G. S., J. W. Precup, and B. C. Kline, Rapid one-step characterization of recombinant vectors by direct analysis of transformed Escherichia coli colonies. Biotechniques, 1989. 7(7): p. 689-90.
20. Looijesteijn P J, Hugenholtz J (1999) Uncoupling of growth and xopolysaccharide production by Lactococcus lactis subsp. cremoris NIZO B40 and optimization of its synthesis. J Biosci Bioeng 88: 178-182.
21. Maere S, Heymans K, Kuiper M (2005) BiNGO: a Cytoscape plugin to assess overrepresentation of gene ontology categories in biological networks. Bioinformatics 21: 3448-3449.

1. A bacterium comprising a modified CPS composition comprising galactosamine and no arabinose.

2. The bacterium comprising a modified CPS composition of claim 1, wherein the bacterium comprises a total molar mass of at least 21, 22, 23, 24, 25, 26, 27, 28, 29, 30 kg/mol and comprising galactosamine and no arabinose.

3. The bacterium comprising a modified CPS composition of claim 1, wherein the bacterium comprises a higher relative total molar mass (kg/mol), preferably 10%, 20%, 30%, 40%, 50%, 60%, 70%, 80%, 90%, 100%, 120%, 130%, 150% higher.

4. The bacterium comprising a modified CPS composition of claim 1, wherein the bacterium comprises a total molar mass of at least 21, 22, 23, 24, 25, 26, 27, 28, 29, 30 kg/mol.

5. The bacterium comprising a modified CPS composition of claim 1, wherein the bacterium comprises at least 0.1%, 0.2%, 0.3%, 0.4%, 0.5%, 0.6%, 0.7%, 0.8%, 0.9%, 1.0%, 1.1%, 1.2%, 1.3%, 1.4%, 1.5% galactosamine of total CPS sugars.

6. The bacterium comprising a modified CPS composition of claim 1, wherein the bacterium comprises less than 1%, 0.9%, 0.8%, 0.7%, 0.6%, 0.5%, 0.4%, 0.3%, 0.2%, 0.1%, 0.05%, 0.01% arabinose of total CPS sugars.

7. The bacterium comprising a modified CPS composition of claim 1, wherein the bacterium comprises at least 10%, 20%, 30%, 40%, 50%, 60%, 70%, 80%, 90%, 95%, 96%, 97%, 98%, 99%, 100% less arabinose.

8. The bacterium comprising a modified CPS composition of claim 1, wherein the bacterium comprises at least 10%, 20%, 30%, 40%, 50%, 60%, 70%, 80%, 90%, 100%, 150%, 200%, 300%, 400%, 500%, 800%, 1000% more galactosamine.

9. The bacterium comprising a modified CPS composition of claim 1, wherein the bacterium comprises at least 0.1%, 0.2%, 0.3%, 0.4%, 0.5%, 0.6%, 0.7%, 0.8%, 0.9%, 1.0%, 1.1%, 1.2%, 1.3%, 1.4%, 1.5% galactosamine of total CPS sugars and comprising less than 1%, 0.9%, 0.8%, 0.7%, 0.6%, 0.5%, 0.4%, 0.3%, 0.2%, 0.1%, 0.05%, 0.01% arabinose of total CPS sugars.

10. The bacterium comprising a modified CPS composition of claim 1, wherein the bacterium comprises at least 10%, 20%, 30%, 40%, 50%, 60%, 70%, 80%, 90%, 95%, 96%, 97%, 98%, 99%, 100% less arabinose and comprising at least 10%, 20%, 30%, 40%, 50%, 60%, 70%, 80%, 90%, 100%, 150%, 200%, 300%, 400%, 500%, 800%, 1000% more galactosamine.

11. The bacterium according to claim 1, wherein the modified CPS composition is modified relative to the CPS composition of a parent bacterium where said bacterium derives from.

12. The bacterium according to claim 1, wherein the bacterium is a probiotic bacterium.

13. A bacterium according to claim 12, wherein the bacterium is a lactic acid bacterium.

14. A bacterium according to claim 13, wherein the bacterium is a Lactobacillus.

15. A bacterium according to claim 14, wherein the bacterium is a Lactobacillus plantarum, preferably a Lactobacillus plantarum WCFS1.

16. A method for the preparation of a bacterium exhibiting enhanced survival properties in the gastro-intestinal tract, said method comprising providing a population of bacteria, culturing said population of bacteria, wherein the culture conditions applied result in reduced expression of one or more polynucleotides selected from the group consisting of:
i. a polynucleotide encoding a polypeptide having at least 30% sequence identity with the amino acid sequence of SEQ ID NO. 1,
ii. a polynucleotide encoding a polypeptide having at least 30% sequence identity with the amino acid sequence of SEQ ID NO. 2, and
iii. a polynucleotide encoding a polypeptide having at least 30% sequence identity with the amino acid sequence of SEQ ID NO. 3, as compared to standard culture conditions.

17. A method according to claim 16, wherein a bacterium exhibiting modulated expression and/or enhanced survival properties in the gastrointestinal tract is isolated from the culture and is optionally purified.

18. A method for the preparation of a food composition, said method comprising providing a population of bacteria, culturing said population of bacteria, wherein the culture conditions applied result in reduced expression of one or more polynucleotides selected from the group consisting of:
i. a polynucleotide encoding a polypeptide having at least 30% sequence identity with the amino acid sequence of SEQ ID NO. 1,
ii. a polynucleotide encoding a polypeptide having at least 30% sequence identity with the amino acid sequence of SEQ ID NO. 2, and
iii. a polynucleotide encoding a polypeptide having at least 30% sequence identity with the amino acid sequence of SEQ ID NO. 3,
as compared to standard culture conditions, optionally isolating and/or purifying the bacterium from the culture broth and contacting the bacterium with a food composition.

19. A food composition comprising a bacterium according to claim 1 or comprising a bacterium obtainable by the method according to claim 16.


SEQUENCE LISTING (80 sequences)

SEQ ID NO: 1 - protein, 709 aa, Lactobacillus plantarum
MQKNGFWATIKDGLRVIGNWLAPYWQRFAAVVGYQWHRRQITRWLIVLVLTVILIGSAYLTYEAKTAKVGNLQAELEKTTEIYDKDNKKAGSLYSQKGTYVHLSSISKNLQNAVISTEDRNFYKEHGFSVKGIGRAFVLLVINKILGRDYISGGGSTLTQQLVKNAYLTQQQTFSRKFREIFLAIETENVYSKGQILAMYLNNAYFGHGVWGAEDASERYFGVHASELSVDQAATLAGMLSSPSGYDPINHPKASTARRNVVLNNMVANNKLSKSEYKLYSQKAMTLTNNYHYESGYNYPYYFDAVIDEAINKYGLTESDIMNRGYKIYTSLDQDDQTQMQDSFKDSTLFPANADDGTKVQGASIAVDPSTGGVLAVVGGRGKHVFRGFNRATQIKRQPGSTIKPLAVYTPALQNGYTYDSNLSNKKQTFGANKYAPKNYDNVYSKSVPMYTALSQSMNIPAVWLLNKIGVNKGYQSVKKFGLPVTKSDDNLALALGGLTTGVSPAQMTSAYTAFANGGKKTTAHFITKIVDASGNVVVDNTKTKTKKIMSASVAKEMTSMMLGTYNSGTGAAAKPYGYSVAGKTGSTQADYSTGSGTKDQWMIAYTPDIVVTTWIGFDTTNSTHYLKSLSENQLSSLFKNELQNILPNTNNTSFGTKDAATLATESNSSDSDSSDSGSSVWENVEKGANAVKNKAKDWFSKAKSFLGN

SEQ ID NO: 2 - protein, 328 aa, Lactobacillus plantarum
MKIMVSEQFQCFMASLGVDLNSLLEAAGINKVVWQEQLMLSDVEYWQLMNEFDNQLTDEMILSLGNITNINTFMPSFFAALAAKNGEQAIARMATYKSLAGPVHLEIVTKPDIVNIHILGNSLGVELPRFTIMTEQLLLISLLRVGTGKLIKPISVGSKYPYGDQIDAVMGIRPQQLADNCIQFQVTDLQRAFISANNSMWAFLQPGLDQQKLAIEHNQSLLATVQALLLKKIPSGSFSIDEIATSLNLSKRTLQRHLSTLSTTFNDEVQIARRTLVVPLMKDQSLNLIEISYLLGYSDPESFSRAFKKWFHQSPSVYRQQSLGMFKN

SEQ ID NO: 3 - protein, 388 aa, Lactobacillus plantarum
MDYVGSLALILIVTAVAGHLSVRMGLPAVIGQLLSGIILGPAVLGWVSATSFIKDFAELGVIILMFMAGLESDLKLLKKYWRPSLLVAVLGVILPVAVIDWCSQLFHLNATESLFLGVTFAATSVSISVAVLKELGALDGKEGTTILGAAVVDDVLAVLILSLMISLFGSEVSGGGSHASTNLGLSLAIQLAFFVALYFVVKWVVPHLMAVGNALLVPTSITLMSLVICFGLSYLADAIGLSAVIGAFFAGIAVGQTDYHEVIDEHIQPIGNAVFIPVFFVSIGLNMSFNGFLNDFWFIVVITVAAIATKLIGAGVGARLAGFNWLSGYEIGAGMVSRGEMALIIAQIGYQGKLLSADRYSAVITAIILTTLIAPLLLRQAVKRQREA

SEQ ID NO: 4 - DNA, 2127 bp, Lactobacillus plantarum
atgcaaaaaaatggtttttgggccacgatcaaagacggcttacgagtcattggcaattggttagcaccctattggcagcgattcgctgccgtcgtcggctaccaatggcaccggcgacaaatcacacggtggctaattgtactcgtcttgaccgtcatcttaattgggagtgcctatttaacttatgaagccaagacggctaaagttggtaatttacaggcggagctagaaaagacaactgaaatctatgataaggacaataaaaaggccggttcactctattcacaaaagggaacctatgtccatttgagtagtatttcaaaaaacttacagaacgcggtaatttcgactgaagaccgtaatttctataaagaacatggtttctcagtcaaaggaatcgggcgggcatttgtcctgctcgttatcaataagatacttggccgtgactacattagtggtggtgggagtacgttgacgcaacaattggtcaaaaacgcctacctaacacaacaacagaccttctcacgtaagtttcgggaaatctttttggcgattgaaactgaaaatgtctattctaagggccaaattttagcgatgtatttgaataacgcttatttcggccacggtgtctggggagctgaggatgcgtctgaacgatattttggcgtacacgcgtcagagttgtctgttgaccaggcggcgaccttggccggaatgctgagctcgcccagtggttatgatccaatcaatcatccgaaagcgtctacggctcgtcgaaacgtcgtcttgaataacatggtcgctaataataagctttccaaaagtgagtataagctttattcgcaaaaggcgatgacgctgacgaataactaccattatgaaagtggttataattatccatattatttcgatgcggtgattgatgaagcaattaataagtacgggctaacggaatctgacattatgaatcggggctataagatttatacgtcgcttgatcaagatgatcagacacagatgcaagattcttttaaggatagtacgttgttcccggccaacgcggacgatggtacgaaggtccaaggggcctcaattgcggttgatccgtcgacgggtggtgtgttagccgtagtcggtggtcggggcaaacacgtcttccggggctttaaccgtgcgactcagattaagcggcagccgggttcgacgatcaaaccgttggcagtgtatacaccagcactacaaaatggttatacgtatgattcgaacctttctaataagaagcaaacttttggggccaataaatatgcgcccaaaaactatgataatgtttatagtaaatcggtcccaatgtataccgcgttatcgcaaagtatgaatattccggcggtttggttattgaataagattggtgtgaataaagggtatcaatcggtgaaaaagtttggcttaccagttaccaagtcggatgataacctggcacttgccttaggtggtttgacgacgggggtatcacccgctcaaatgaccagtgcctatacagcgtttgcgaatggtggtaagaaaacgacggcccactttattacgaaaattgtcgatgctagtggcaatgtcgttgtcgataatacgaagactaagacgaagaaaattatgtccgccagcgttgctaaagaaatgaccagtatgatgcttggcacgtacaatagtgggaccggggctgcggccaagccgtatggatactcggttgctggtaagactgggagtacgcaggctgattacagtacgggttcgggaacgaaggatcagtggatgattgcttataccccggacattgtggtcacgacctggatcggatttgatacgacgaacagtactcattatttgaagagtttatctgaaaatcaactttcctcgttattcaagaatgaattacaaaatattttgccgaatacgaataatactagttttggtacgaaggatgctgcgacgctggcaaccgaatctaatagtagtgattcggatagttctgatagtggatcatccgtatgggaaaacgttgagaagggcgctaatgcagttaagaacaaggctaaagactggttctccaaagccaaaagtttccttggcaac

SEQ ID NO: 5 - DNA, 984 bp, Lactobacillus plantarum
gtgaagattatggtttctgaacagtttcagtgttttatggcaagccttggcgttgatttaaatagcctgcttgaagctgccggtattaataaagtggtttggcaagaacaattaatgctttctgatgtggagtattggcagttaatgaacgaattcgacaaccaattgacggatgaaatgattcttagtttagggaatattactaacattaatacgtttatgccgtccttttttgcagcattagctgctaaaaatggtgaacaagcgattgcacgcatggcaacctataaatcattggcaggtccggttcatttagagatagtgaccaagccagatattgtcaatattcatattttgggaaatagtcttggcgtcgagttgccgcgtttcacgattatgacggaacaattgttgttaatcagcttgttacgagtaggtacgggaaaactcatcaagccaatttcagttggtagtaagtatccgtatggtgatcagattgatgccgtgatgggcattcgacctcaacaattggctgataattgcattcagtttcaagtcacggacttacagcgggcgtttatttcggccaataattcaatgtgggcatttttgcaaccagggttagaccaacaaaaactggctattgaacacaaccaatcattgctcgcgactgttcaagcactattgttgaagaaaattcctagtggttccttctcaattgacgagattgcaacaagtttgaatctcagtaaacgaaccttgcagcgtcatcttagtactttaagcaccacatttaatgatgaagtccaaattgcgcgtcgaaccctagtggtacccttgatgaaagatcaatcgctaaacttgattgaaatcagctatttgttagggtattcagacccagagtctttttcgagagcttttaaaaaatggtttcatcagagtccatccgtttaccgccaacaatctctggggatgttcaaaaat

SEQ ID NO: 6 - DNA, 1164 bp, Lactobacillus plantarum
atggattacgttggtagtttagcgttgattttaattgttacggcggttgcgggtcacctgagtgtccgaatgggcctacccgcggtgattggccaattgttaagtggaattatacttggtccagccgtattaggttgggtctcagcaacaagttttatcaaagacttcgcggagcttggcgtgattattttaatgttcatggccggcttagagagcgatttgaaattgctgaagaagtattggcgtcctagtttgttagttgcggtcctgggggtcattctacccgttgcggtgattgactggtgtagccaactatttcaccttaacgccactgaaagtttgttcttgggcgtaaccttcgcggccacatcggtttcgatttcagtcgcggttctcaaagagttaggcgctctcgatggtaaagaagggacgacgattttaggtgcagcggtcgttgatgacgtcctggctgttttgattctgagtttgatgatcagcttatttggcagtgaagtcagtggtggcggtagtcatgcctcaaccaacttgggactctcgctggcgattcagttggcgttctttgtggcgctgtactttgtggtcaagtgggtggtgccacatttaatggccgtggggaatgccctactggttccaacctccatcacgctgatgtcactagtgatttgttttggactctcatacttagcggacgcaatcggtttaagtgctgtgattggcgcgttctttgccggtatcgccgttggtcagacggactatcatgaagttatcgatgagcatattcaacccattggtaatgctgtatttatcccagtctttttcgttagtattgggctgaatatgtcattcaatggtttcttgaacgatttttggttcatcgttgtgattaccgttgcggcaattgccactaagctcattggtgccggggtcggcgcacggttagcgggttttaattggttaagcggctatgagattggcgctggcatggtgtcacgtggggagatggccctgatcattgcacagataggttatcaaggcaaattactatcagctgatcgttattcggcagtcatcacagcaatcattttaacgacgctgattgcaccgctattacttcgtcaggcggttaaacgccagcgtgaagct

SEQ ID NO: 7 - DNA, 4127 bp, Lactobacillus plantarum
tttgctataatgtattcattacaagatttggggaggtttcgcgacatgaaaaagtcagagcgccaagcagttatcgaacaattaattagtgaatatccgatcgctacccaggaagaattgatggctaagcttaaagcagagggcattgctgcgacgcaagcgacgatttcgcgcgatatccgagagatgcagatcgttaagacgccggatgagcacggtcagacgcggtacgcgatttttaaaacaactaacaaaaatgaacaggaccggctatttgaaacgctacacgatgtggtcacgagcattgaccgtgttgaattcatgaatattattcatacgctaccgagtaatgggaatctattggcggcgatcattgatgatttgaacttgccagaagtgagtgggaccttggctggtcacgacacgatctttgtcgtgagtccgaatacgacggtggcaaagcagctatacgaatcctttgctagtcacattagtaatgaagactgactgtggtgagcagtctaattggttgcactaagccgtcgttcacggtatgattattgtcatcaaaagaggtgtgagatatgaaatatacgaagaaacgggcgcctcgaaagaatcaaaaacaacgcgatgcgaccttcgataaatttaaacaacaacaaaatgagctcaacgctaaccgccggggtgtccggcgcaagtaatggctgagctagctttcaagtatgtcatatggacggctcggaagctttttttgtttatggccgttttatcgtagtgacctttaatctggttacaacacgcggcctaaatcagtgatttcggcaacaactggcaaacatcgggttatctacaaaatgagttgcgtttgattgttgaagattttttcaaggttgtggtcaattactgagcatcggaaaatttatgatacaattgtaaaagctaacaagtaacgcggacgttgtgacaggtgcgtcggctgaacaaggggaagattatgcaaaaaaatggtttttgggccacgatcaaagacggcttacgagtcattggcaattggttagcaccctattggcagcgattcgctgccgtcgtcggctaccaatggcaccggcgacaaatcacacggtggctaattgtactcgtcttgaccgtcatcttaattgggagtgcctatttaacttatgaagccaagacggctaaagttggtaatttacaggcggagctagaaaagacaactgaaatctatgataaggacaataaaaaggccggttcactctattcacaaaagggaacctatgtccatttgagtagtatttcaaaaaacttacagaacgcggtaatttcgactgaagaccgtaatttctataaagaacatggtttctcagtcaaaggaatcgggcgggcatttgtcctgctcgttatcaataagatacttggccgtgactacattagtggtggtgggagtacgttgacgcaacaattggtcaaaaacgcctacctaacacaacaacagaccttctcacgtaagtttcgggaaatctttttggcgattgaaactgaaaatgtctattctaagggccaaattttagcgatgtatttgaataacgcttatttcggccacggtgtctggggagctgaggatgcgtctgaacgatattttggcgtacacgcgtcagagttgtctgttgaccaggcggcgaccttggccggaatgctgagctcgcccagtggttatgatccaatcaatcatccgaaagcgtctacggctcgtcgaaacgtcgtcttgaataacatggtcgctaataataagctttccaaaagtgagtataagctttattcgcaaaaggcgatgacgctgacgaataactaccattatgaaagtggttataattatccatattatttcgatgcggtgattgatgaagcaattaataagtacgggctaacggaatctgacattatgaatcggggctataagatttatacgtcgcttgatcaagatgatcagacacagatgcaagattcttttaaggatagtacgttgttcccggccaacgcggacgatggtacgaaggtccaaggggcctcaattgcggttgatccgtcgacgggtggtgtgttagccgtagtcggtggtcggggcaaacacgtcttccggggctttaaccgtgcgactcagattaagcggcagccgggttcgacgatcaaaccgttggcagtgtatacaccagcactacaaaatggttatacgtatgattcgaacctttctaataagaagcaaacttttggggccaataaatatgcgcccaaaaactatgataatgtttatagtaaatcggtcccaatgtataccgcgttatcgcaaagtatgaatattccggcggtttggttattgaataagattggtgtgaataaagggtatcaatcggtgaaaaagtttggcttaccagttaccaagtcggatgataacctggcacttgccttaggtggtttgacgacgggggtatcacccgctcaaatgaccagtgcctatacagcgtttgcgaatggtggtaagaaaacgacggcccactttattacgaaaattgtcgatgctagtggcaatgtcgttgtcgataatacgaagactaagacgaagaaaattatgtccgccagcgttgctaaagaaatgaccagtatgatgcttggcacgtacaatagtgggaccggggctgcggccaagccgtatggatactcggttgctggtaagactgggagtacgcaggctgattacagtacgggttcgggaacgaaggatcagtggatgattgcttataccccggacattgtggtcacgacctggatcggatttgatacgacgaacagtactcattatttgaagagtttatctgaaaatcaactttcctcgttattcaagaatgaattacaaaatattttgccgaatacgaataatactagttttggtacgaaggatgctgcgacgctggcaaccgaatctaatagtagtgattcggatagttctgatagtggatcatccgtatgggaaaacgttgagaagggcgctaatgcagttaagaacaaggctaaagactggttctccaaagccaaaagtttccttggcaactagtaaagctagcttctgaacgtactaatgctattcaagttccgttaaaaatgctaaaataatgacgacacatacttcgaggaggaactcacgatggccgtaaatatttacgatactgcgaaccaattggaacaagaattacgtcagactaaagaattcaaggaattaaaggtcgcttatgacacgatgaagaccaatgacagtgccttttcactgtttaaggactttcaagaagttcagatgcaattgtcacaaaagcagatgaatggggaagaattgacggatgacgaagttcaaaaggcccatgatttagctgataaggttggcaacgttgacgaaattaagtccttaatgggtaaagaacgtaacttgaaccaattgatgaatgatttaaatcaaattatcactaaaccagttcaagcattataccagaactaagtaaattaaggatcgaggggcaatgacggaatctgttccgtgattgccccttttttagtgggggttatcatgaaatttctacacgcggcagatttacatttagatacaccgtttcaaggactgagtggcttaacaccagctttgcaggaacggttagtgacggcaccactgagggcactcagccgactagtcgatttggcggtggctgagcaagtcgatttcgtcctgctcgttggtgacttgtttgaccaacagggccaaagtgttcaggcccaggcggcactgatgacggcgctagcgcggttgaatacggcttcgattccggtgctgctatcgttcggtaaccatgattttcaagcggatttaagtcgctggcactttccggccaatgtgcacgtgtttggcccgcaggtaacaacggctaccttaacgactgtggcacaagaacgggtcgcgattagtgggtttagctatgcgcagcggtgggtgacgacggacccagttgatgattatcctgttaaagccacgggcgttgattatcagattggtaccttgcacggtc

SEQ ID NO: 8 - DNA, 2984 bp, Lactobacillus plantarum
cgccaggcgtaatgagtgtgattttgcagttgtttgagttgattaatatcagctgttaatggcctgcgccaaaaaatggcatattatgttatgatgatgacgtgataaatcattaagccgttgcgattttctatgtaaactattgttattgaaaaacataggaggtcattgagatggcagttattttaattacgggtgcaagcagcggtattgggtttcagacagcgaaagacttagcacagcaaggtcacgttgtttacggtgcggcgcggcggttgaataaacttgaagcactagccccatacggcgttaagcccttgtcactagatataaccaatgagcagtcgcttagtcaggccgtagcaactttaattgccagtgaaggacgcattgatgttttgatcaacaatgcggggtatggctcatatggcgctgtggaggatgtttccattgatgaagccaggcaacagttcgaggttaatttatttgggatggctcggctgacacaattagttttaccgtatatgcgcgcgcaacgtgaaggacgcattatcaatacctcttccatgggtggacggttggtgagttatatgggcgcatggtatcacgcaaccaagtacgctgtcgaagcgtttagtgacgcattacgaatggagactaaagactttggcattaaagttgcaattattgaacctggtgggattaaaaccaactggggattcattgctgcggatcatttagaagcctcagcacgtcacagtgcatatcaaacacaagcgaccaaggctgccgcgggtatgcgccgacaatactcgtcgcgaatgatgtctgatccaaaaattatttctaaagctatttcgaaggcggtcaatcagaaacgaccacgggtgcgttatttaattggatttggggctaaaccgctggtacttgctaaggcgattttaccgactcgtgtttttgattttatcatgatgcatgccagttagtaggagtgattagtgtgaagattatggtttctgaacagtttcagtgttttatggcaagccttggcgttgatttaaatagcctgcttgaagctgccggtattaataaagtggtttggcaagaacaattaatgctttctgatgtggagtattggcagttaatgaacgaattcgacaaccaattgacggatgaaatgattcttagtttagggaatattactaacattaatacgtttatgccgtccttttttgcagcattagctgctaaaaatggtgaacaagcgattgcacgcatggcaacctataaatcattggcaggtccggttcatttagagatagtgaccaagccagatattgtcaatattcatattttgggaaatagtcttggcgtcgagttgccgcgtttcacgattatgacggaacaattgttgttaatcagcttgttacgagtaggtacgggaaaactcatcaagccaatttcagttggtagtaagtatccgtatggtgatcagattgatgccgtgatgggcattcgacctcaacaattggctgataattgcattcagtttcaagtcacggacttacagcgggcgtttatttcggccaataattcaatgtgggcatttttgcaaccagggttagaccaacaaaaactggctattgaacacaaccaatcattgctcgcgactgttcaagcactattgttgaagaaaattcctagtggttccttctcaattgacgagattgcaacaagtttgaatctcagtaaacgaaccttgcagcgtcatcttagtactttaagcaccacatttaatgatgaagtccaaattgcgcgtcgaaccctagtggtacccttgatgaaagatcaatcgctaaacttgattgaaatcagctatttgttagggtattcagacccagagtctttttcgagagcttttaaaaaatggtttcatcagagtccatccgtttaccgccaacaatctctggggatgttcaaaaattaacaagcgttgccgtttaggttaaaagttatgggcgttaaaatcttatggatgtgatggctttagactgatgagtaatcctttaaattaatagatcgtcacaacaattgtgtttaagaatgctagttcttagatgcaattttttttgcgtgcatctaagctagtgacagttgaacagattgtatcattgcttgctgaagtcaaaacttgttagcaatttgattataaactttatagtcaaattgctaaactgtgccagttcgttgacggattatgaccgcaaaaaatggctcgtcaagaaattttcgcaaaaaaataaagctcgattagagcccagcttaccgggatttggctactaaaaaatgtaacatactgtaaattaatctgctgaaatcaattgacaagatttggccggacgattaacttaatgccattcccaaacgccgtgaaaggagcgactaactatgagtgtgttagaagcaagtgaaattatgcaattaatccccaaccggtacccaattttattcatggaccgggtggatgaattaaatccgggtgaatcgatcgtggtgacgaaaaatgtcacgattaatgagtcatttttccaagggcactttcccggtaacccggtcatgccgggcgtgttgattattgaagctttggcgcaagccgcgtcgattctgattttgaaatctgaaaagtttgctggtaagacggcttatcttggcgccattaaggatgccaagttccgcaaaattgtccgtcccggtgatgtcttgaagttgcatgtccaaatggtcaagcaacggtccaacatgggaacggtgagttgtcaggcgatggtcggtgacaaggcagcctgcacaactgatttaacctttatcgttggtgcaactgattcaaaatagaaaggtggtaatggcaattcggcgattgtcgtttgggaaagttttttaaaagtattgccgaattgtaaccaaccatgacaactaatttttcg

SEQ ID NO: 9 - DNA, 3164 bp, Lactobacillus plantarum
aacgagcaggccgacgagcatgagaatgaacatcaaaatgatttgactagttagttgcgttaaattcatttacttcagtccaataaattagaatactctcattattgaggcttggcctgaactttgtcaagattcatttaggccggatgatgcgcctggacaatatccacgtgatgtttgagatggggaaaaacatgatgatcagaccaccccatgatggcaccttgagcaattaaggcaaagaccgtcccgaagccaatggcgcgcaaatgacctgtggcgaagaatgaaacgacgataatcgtcagaggtggcaaataactggtccactgagcaataatagcggagccatgtaaaaaccgaaagcgtaagatatatgataaatcatcgttcggatgctgaattaaattacaacgctggtaaatcgagacggcggccgcaacgcctaatagcccgagcacgtttagaatcaagcgtggtaacaggggcagggcgggaatctgtagccaatcccaaaagtagccgataaattggaccaggtaactaaagggcacgatatagagcaagttggagataaaacgacgccgatcaaagtgacctaacagaagttggttgagaatcgtgacaaccacaccgtacagtaataaggtggttcctaatgaaatatgggtccagtcagctagattaacgctggagccagtccagacggcgctgcctaggctggtgagcgcgtggcagcagaattcagaataatggaaaagactaaaaacccaaaacgttgacgaaaatcaggaatgttcaacacgactaagcgacctttcagttaacagtatatgagttattataaccgctttcataagtagatgtcacggctagactcataaaaatatgctatactaattgcacaatagattttacggttgaaggacacttcaagaattcggactacttttgggttgggtagtcagagcttgcagtgcccttttttaggaggtttttaatggattacgttggtagtttagcgttgattttaattgttacggcggttgcgggtcacctgagtgtccgaatgggcctacccgcggtgattggccaattgttaagtggaattatacttggtccagccgtattaggttgggtctcagcaacaagttttatcaaagacttcgcggagcttggcgtgattattttaatgttcatggccggcttagagagcgatttgaaattgctgaagaagtattggcgtcctagtttgttagttgcggtcctgggggtcattctacccgttgcggtgattgactggtgtagccaactatttcaccttaacgccactgaaagtttgttcttgggcgtaaccttcgcggccacatcggtttcgatttcagtcgcggttctcaaagagttaggcgctctcgatggtaaagaagggacgacgattttaggtgcagcggtcgttgatgacgtcctggctgttttgattctgagtttgatgatcagcttatttggcagtgaagtcagtggtggcggtagtcatgcctcaaccaacttgggactctcgctggcgattcagttggcgttctttgtggcgctgtactttgtggtcaagtgggtggtgccacatttaatggccgtggggaatgccctactggttccaacctccatcacgctgatgtcactagtgatttgttttggactctcatacttagcggacgcaatcggtttaagtgctgtgattggcgcgttctttgccggtatcgccgttggtcagacggactatcatgaagttatcgatgagcatattcaacccattggtaatgctgtatttatcccagtctttttcgttagtattgggctgaatatgtcattcaatggtttcttgaacgatttttggttcatcgttgtgattaccgttgcggcaattgccactaagctcattggtgccggggtcggcgcacggttagcgggttttaattggttaagcggctatgagattggcgctggcatggtgtcacgtggggagatggccctgatcattgcacagataggttatcaaggcaaattactatcagctgatcgttattcggcagtcatcacagcaatcattttaacgacgctgattgcaccgctattacttcgtcaggcggttaaacgccagcgtgaagcttaaagcaattgaaaatcccaacttgtttgcgtgttgcaaacaggctgggattttttaatcacgacattattcagttgttaaacgttgatagtggacttcggcgagctgaccatatcgattggtgtcaactaattcaaagcgctgttgctggtcaattgctttaaacaagggaataccatcacccaaaatgactggtgcaatctggatgtagagctcatcaactaaatccgcagctaacagcggcattaagacgccagcaccgccaacaatccaaatgtttttgccagcggtacggcgcaagtcttcgacaatcttcgtgacgggggtattggtgaactgggtgcgttcatcgccggtgtgggggtgggaagtcatgacaatattgtgggtcgccggattatatggattaatgagttgatcagtggtttgttccatcgtgtattcgtaagtatggcggcccatgatggcggtatcaacttgctgcataaatgcttcggtaggggcatcgttggcaccagctgttttgaacagccagtccagccgattatccttagtggctaaacaaccgtcaattgaaatggccccataaaactgaactttacgcatgattcgacacctactttatctttagtagtcatattgtaccatgttttccggtcattcacttgctgaactccggtaaaagttcagtaacataattaaataattggttcgaaatgggaggtgggaaactacttaaggtgtcgctgggagcgtatgaatactgcaaataatgatgttgcggggctaatggggatgagtattcacagcggttaagcaggcagtggtgggctgtgatgatcattgtcagggaagtagcatacgggcaatcaagatgtgagtcgaagtaacgattggtggttttcaagggccccactgtccgctataattagtctagcatttcatcacatacagtttgacctaattaggcgagctggcctggttcgtaaacttcccagga

SEQ ID NO: 10-19 - skipped (10 entries)

SEQ ID NO: 20 - DNA, 22 bp, Artificial
  PCR primer
tttgctataatgtattcattac

SEQ ID NO: 21 - DNA, 20 bp, Artificial
  PCR primer
agttctgtgcgtagtttgcc

SEQ ID NO: 22 - DNA, 54 bp, Artificial
  PCR primer
gcatacattatacgaacggtagattttttttgcataatcttccccttgttcagc

SEQ ID NO: 23 - DNA, 43 bp, Artificial
  PCR primer
cggttacagcccgggcatgagtagtaaagctagcttctgaacg

SEQ ID NO: 24 - DNA, 20 bp, Artificial
  PCR primer
gaccgtgcaaggtaccaatc

SEQ ID NO: 25 - DNA, 20 bp, Artificial
  PCR primer
tagtggtcacccgccacacc

SEQ ID NO: 26 - DNA, 21 bp, Artificial
  PCR primer
atcatggcttaatcaacagcg

SEQ ID NO: 27 - DNA, 20 bp, Artificial
  PCR primer
cgccaggcgtaatgagtgtg

SEQ ID NO: 28 - DNA, 50 bp, Artificial
  PCR primer
gcatacattatacgaacggtagatttaatcttcacactaatcactcctac

SEQ ID NO: 29 - DNA, 42 bp, Artificial
  PCR primer
cggttacagcccgggcatgagtaacaagcgttgccgtttagg

SEQ ID NO: 30 - DNA, 20 bp, Artificial
  PCR primer
cgaaaaattagttgtcatgg

SEQ ID NO: 31 - DNA, 20 bp, Artificial
  PCR primer
aaattagttgtcatggttgg

SEQ ID NO: 32 - DNA, 20 bp, Artificial
  PCR primer
cgcgacagagaagtccaacc

SEQ ID NO: 33 - DNA, 19 bp, Artificial
  PCR primer
tttcgtagacgagtcaaag

SEQ ID NO: 34 - DNA, 52 bp, Artificial
  PCR primer
gcatacattatacgaacggtagatttatttaacatcttatgacctctttttc

SEQ ID NO: 35 - DNA, 45 bp, Artificial
  PCR primer
cggttacagcccgggcatgagtaaagacggtaaagctcgtgttac

SEQ ID NO: 36 - DNA, 20 bp, Artificial
  PCR primer
atatgatcaacttcctgatt

SEQ ID NO: 37 - DNA, 20 bp, Artificial
  PCR primer
catgtacataagatagatcc

SEQ ID NO: 38 - DNA, 20 bp, Artificial
  PCR primer
ggtaatcatagcaacattag

SEQ ID NO: 39 - DNA, 20 bp, Artificial
  PCR primer
cataccaggttgtgtcacgg

SEQ ID NO: 40 - DNA, 53 bp, Artificial
  PCR primer
gcatacattatacgaacggtagatttattctgcatcgtttattccgtaattcg

SEQ ID NO: 41 - DNA, 52 bp, Artificial
  PCR primer
cggttacagcccgggcatgagtaaggatgatcaattcaagttagttaaaatg

SEQ ID NO: 42 - DNA, 20 bp, Artificial
  PCR primer
gttgattaacaaaattactg

SEQ ID NO: 43 - DNA, 20 bp, Artificial
  PCR primer
tcaatatcattttcagtttg

SEQ ID NO: 44 - DNA, 20 bp, Artificial
  PCR primer
agtctgggcatgcatgaagc

SEQ ID NO: 45 - DNA, 19 bp, Artificial
  PCR primer
aacgagcaggccgacgagc

SEQ ID NO: 46 - DNA, 55 bp, Artificial
  PCR primer
gcatacattatacgaacggtagatttgtaatccattaaaaacctcctaaaaaagg

SEQ ID NO: 47 - DNA, 46 bp, Artificial
  PCR primer
cggttacagcccgggcatgagtaaagcaattgaaaatcccaacttg

SEQ ID NO: 48 - DNA, 20 bp, Artificial
  PCR primer
tcctgggaagtttacgaacc

SEQ ID NO: 49 - DNA, 20 bp, Artificial
  PCR primer
ccgataactgaagttcttgg

SEQ ID NO: 50 - DNA, 31 bp, Artificial
  PCR primer
ccccctcatgaagcagttctggtcactaatc

SEQ ID NO: 51 - DNA, 21 bp, Artificial
  PCR primer
ctaactctttgtcccggttgg

SEQ ID NO: 52 - DNA, 34 bp, Artificial
  PCR primer
cccccccatggctcgtaaatatggtgtgatcggg

SEQ ID NO: 53 - DNA, 22 bp, Artificial
  PCR primer
ttatgcttgcggtaaaacgtcc

SEQ ID NO: 54 - DNA, 31 bp, Artificial
  PCR primer
ccccctcatgaaaacactttatcgcagtacc

SEQ ID NO: 55 - DNA, 26 bp, Artificial
  PCR primer
tcagttgaagtaattttctaggaaaa

SEQ ID NO: 56 - DNA, 39 bp, Artificial
  PCR primer
cccccacatgtctcaaaacaagcaatccaattcaattcg

SEQ ID NO: 57 - DNA, 22 bp, Artificial
  PCR primer
ttatgccttaaacggattccag

SEQ ID NO: 58 - DNA, 27 bp, Artificial
  PCR primer
aatagttatctattatttaacgggagg

SEQ ID NO: 59 - DNA, 21 bp, Artificial
  PCR primer
gccgactgtactttcggatcc

SEQ ID NO: 60 - DNA, 24 bp, Artificial
  PCR primer
agaacaatcaaagcgagaataagg

SEQ ID NO: 61 - DNA, 20 bp, Artificial
  PCR primer
ttatcatatcccgaggaccg

SEQ ID NO: 62 - DNA, 21 bp, Artificial
  PCR primer
cgataccgtttacgaaattgg

SEQ ID NO: 63 - DNA, 21 bp, Artificial
  PCR primer
cttgctcataagtaacggtac

SEQ ID NO: 64 - DNA, 23 bp, Artificial
  PCR primer
tcaaatacagcttttagaactgg

SEQ ID NO: 65 - DNA, 22 bp, Artificial
  PCR primer
atcacaaacagaatgatgtacc

SEQ ID NO: 66 - DNA, 22 bp, Artificial
  PCR primer
gcgtacttagctggccagcata

SEQ ID NO: 67 - DNA, 23 bp, Artificial
  PCR primer
gtaattgctttatcaactgctgc

SEQ ID NO: 68 - DNA, 28 bp, Artificial
  PCR primer
gtgacccaaaccggagccaatactagtg

SEQ ID NO: 69 - DNA, 28 bp, Artificial
  PCR primer
cttagctgatttttgggccggcttcgtg

SEQ ID NO: 70 - DNA, 29 bp, Artificial
  PCR primer
accatacttacaacaacttgaactcaacc

SEQ ID NO: 71 - DNA, 29 bp, Artificial
  PCR primer
ttacattccagacgttcaagctgattacc

SEQ ID NO: 72 - DNA, 25 bp, Artificial
  PCR primer
gcttgattccgcagtcctatccagg

SEQ ID NO: 73 - DNA, 27 bp, Artificial
  PCR primer
gacggcgcgatcgtcgctaacgaccgg

SEQ ID NO: 74 - DNA, 29 bp, Artificial
  PCR primer
gatctctacaacgatgatttttgatgaag

SEQ ID NO: 75 - DNA, 27 bp, Artificial
  PCR primer
tcgcaaaatttgttcaggctgaacggg

SEQ ID NO: 76 - DNA, 42 bp, Artificial
  Sequence tag for pbp2A
catacttagagtgagtctaggttcctttcagcctatgagtgt

SEQ ID NO: 77 - DNA, 42 bp, Artificial
  Sequence tag for Lp-1669
gtcccttccaaactttcttacttgcactcagtgagccttaga

SEQ ID NO: 78 - DNA, 42 bp, Artificial
  Sequence tag for Lp-1817
cttgctatgtatcatactgccttggtctctaccttgctcaga

SEQ ID NO: 79 - DNA, 43 bp, Artificial
  Sequence tag for pacL3
ctaactatgtctctttcatgcatccttgcattgtctgatsact

SEQ ID NO: 80 - DNA, 42 bp, Artificial
  Sequence tag for nap3A
ctttgtttctctctgtctctcactgaccgtatgaaacagtgt